(19) United States
(12) Patent Application Publication
(10) Pub. No.: US 2004/0180301 A1
(43) Pub. Date: Sep. 16, 2004

(54) Photothermographic material and image-forming method using same

(76) Inventor: Hajime Nakagawa, Kanagawa (JP)

Correspondence Address: MS. YUMI YERKS, 2111 JEFFERSON DAVIS HIGHWAY, APARTMENT #412, NORTH, ARLINGTON, VA, 22202, US

(21) Appl. No.: 10/788,403

(22) Filed: Mar. 1, 2004

(30) Foreign Application Priority Data
Mar. 5, 2003 (JP) 2003-58205

(51) Int. Cl. G03C 5/16; G03C 1/498

(52) U.S. Cl. 430/350; 430/531; 430/619; 430/620

(57) ABSTRACT

A photothermographic material containing a photosensitive silver halide, a reducing agent, a binder having a glass-transition temperature of 70 to 110° C., and a non-photosensitive organic silver salt, wherein (i) the reducing agent is a compound represented by the following general formula (R), (ii) the photothermographic material comprises a development accelerator, or (iii) the non-photosensitive organic silver salt contains 50% by mole or more of silver behenate.

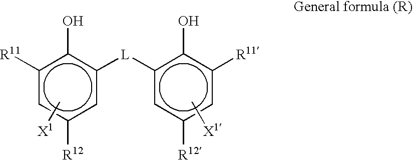

### CROSS-REFERENCE TO RELATED APPLICATIONS

This application claims priority to Japanese patent application number 2003-58205 filed Mar. 5, 2003, the disclosure of which is incorporated herein by reference.

### BACKGROUND OF THE INVENTION

1. Field of the Invention

The present invention relates to a thermally developable photosensitive material (hereinafter referred to as photothermographic material), and particularly to a photothermographic material excellent in film storability, image storability, and development activity, and a method for forming an image on the photothermographic material.

2. Description of the Related Art

In recent years, in the fields of medical diagnostic films and photo-printing and photo-press films, reduction of processing waste has been strongly desired from the viewpoints of environmental preservation and space saving. Thus, there has been demand for technologies relating to photothermographic materials usable as medical diagnostic films or photo-printing and photo-press films, which can be effectively exposed by a laser image setter or a laser imager to form a clear black image with high resolution and sharpness. Such photothermographic materials can provide heat-developing systems, which need no liquid processing chemicals and can more simply form an image without harming the environment.

Though there is a similar demand in the field of general image-forming materials, fine depictions are particularly needed in the field of medical diagnostic imaging. Thus, medical diagnostic images are required to have high image quality with excellent sharpness and graininess, and they are preferably a blue black tone image from the viewpoint of ease of diagnoses. Various hard copy systems using pigments or dyes, such as ink jet printers, and electrophotographic systems, are widely distributed as general image-forming systems at present. However, the systems are not satisfactory as output systems for medical images.

Heat image-forming systems using organic silver salts are described in the literature. In particular, photothermographic materials generally have an image-forming layer in which a catalytically active amount of a photocatalyst such as a silver halide, a reducing agent, a reducible silver salt such as an organic silver salt, and an optional color toning agent for controlling color tone of silver are dispersed in a binder matrix.

When the photothermographic material is exposed and then heated to a high temperature (e.g. 80° C. or more), a black-colored silver image is formed by an oxidation-reduction reaction between the reducing agent and the reducible silver salt which acts as an oxidizing agent. The oxidation-reduction reaction is accelerated by catalytic activity of a silver halide latent image generated by the exposure, and as a result, the black-colored silver image is formed in the exposed region.

The photothermographic material contains all chemical substances required for the development, and thus there is a problem with respect to unprocessed stock storability in that an increase in fogging occurs in which unexposed portions are blackened due to storage between production and use of the photosensitive material. Particularly, when the photothermographic material is removed from the package and placed in a heat developing apparatus, the photothermographic material is easily affected by its environment, so that photographic properties, particularly color tone, are deteriorated with time. Further, the photothermographic material has a disadvantage of a so-called printout in which the unexposed portions are gradually blackened when the formed image is left under conditions of high temperature and high humidity after heat development.

As described in JP-A No. 2002-287292, etc., combinations of a chemical sensitization and use of a high Tg binder have been examined to increase the storage stability of the photothermographic material. However, although the sensitivity change of the stored material is improved, tone change of the stored photothermographic material is not described.

Particularly, the aforementioned problems are more conspicuous in organic solvent-applied type photothermographic materials using a solvent binder such as polyvinyl butyral than in water-applied type photothermographic materials using a polymer latex. It is presumed from comparison between both of these that the instability is promoted by the residual organic solvent. Accordingly, in the case of using an organic solvent as an coating solvent, sensitization techniques capable of providing excellent storage stability are desired.

Further, in heat developing methods in which the image-forming layer side of the photothermographic material is heated by a heat drum, the photothermographic material easily adheres to the heat drum. Thus, defective feeding is often caused in such methods, so that it is desired to improve the photothermographic materials.

### SUMMARY OF THE INVENTION

Accordingly, a first object of the present invention is to provide a photothermographic material that shows improved storage stability before development processing, a photothermographic material that shows improved storage stability (image color tone change) in a heat developing apparatus, and methods for forming an image on the photothermographic materials. A second object of the present invention is to provide a photothermographic material capable of forming an image with excellent storability, and methods for forming an image on the photothermographic material. A third object of the present invention is to provide a photothermographic material capable of preventing defective feeding in a heat developing process, and methods for forming an image on the photothermographic material.

The above objects of the present invention have been achieved by the following photothermographic materials.

A first aspect of the present invention is a photothermographic material comprising an image-forming layer comprising a photosensitive silver halide, a reducing agent, a binder, and a non-photosensitive organic silver salt, wherein said binder has a glass-transition temperature of 70° C. to 110° C., and said reducing agent is a compound represented by the following general formula (R):

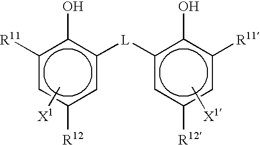

wherein R¹¹ and R^{11′} each independently represents a secondary or tertiary alkyl group having a carbon number of 3 to 15, R¹² and R^{12′} each independently represents a hydrogen atom or a substituent which is capable of substituting on a benzene ring, L represents a —S— group or a —CHR¹³— group, R¹³ represents a hydrogen atom or an alkyl group having a carbon number of 1 to 20, and X¹ and X^{1′} each independently represents a hydrogen atom or a substituent which is capable of substituting on a benzene ring.

A second aspect of the present invention is a photothermographic material comprising:

an image-forming layer comprising a photosensitive silver halide, a reducing agent, a binder, and a non-photosensitive organic silver salt, wherein said binder has a glass-transition temperature of 70° C. to 110° C., and said photothermographic material comprises a development accelerator.

A third aspect of the present invention is a photothermographic material comprising an image-forming layer comprising a photosensitive silver halide, a reducing agent, a binder, and a non-photosensitive organic silver salt, wherein said binder has a glass-transition temperature of 70° C. to 110° C., and said non-photosensitive organic silver salt comprises silver behenate in an amount of 50% by mole or more.

A fourth aspect of the present invention is a method for forming an image comprising: exposing the photothermographic material according to the first aspect to a radiation source and developing the photothermographic material, wherein the maximum density of the photothermographic material is 3.3 or more.

A fifth aspect of the present invention is a method for forming an image comprising: exposing the photothermographic material according to the second aspect to a radiation source and developing the photothermographic material, wherein the photothermographic material is developed by heating for 3 to 13 seconds.

### DETAILED DESCRIPTION OF THE INVENTION

A first aspect of the present invention is a photothermographic material comprising an image-forming layer comprising a photosensitive silver halide, a reducing agent, a binder, and a non-photosensitive organic silver salt, wherein said binder has a glass-transition temperature of 70° C. to 110° C., and said reducing agent is a compound represented by the following general formula (R):

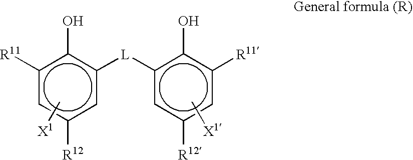

wherein R¹¹ and R^{11′} each independently represents a secondary or tertiary alkyl group having a carbon number of 3 to 15, R¹² and R^{12′} each independently represents a hydrogen atom or a substituent which is capable of substituting on a benzene ring, L represents a —S— group or a —CHR¹³— group, R¹³ represents a hydrogen atom or an alkyl group having a carbon number of 1 to 20, and X¹ and X^{1′} each independently represents a hydrogen atom or a substituent which is capable of substituting on a benzene ring.

A second aspect of the present invention is a photothermographic material comprising:

an image-forming layer comprising a photosensitive silver halide, a reducing agent, a binder, and a non-photosensitive organic silver salt, wherein said binder has a glass-transition temperature of 70° C. to 110° C., and said photothermographic material comprises a development accelerator.

A third aspect of the present invention is a photothermographic material comprising an image-forming layer comprising a photosensitive silver halide, a reducing agent, a binder, and a non-photosensitive organic silver salt, wherein said binder has a glass-transition temperature of 70° C. to 110° C., and said non-photosensitive organic silver salt comprises silver behenate in an amount of 50% by mole or more.

A fourth aspect of the present invention is a method for forming an image comprising: exposing the photothermographic material according to the first aspect to a radiation source and developing said photothermographic material, wherein the maximum density of said photothermographic material is 3.3 or more.

A fifth aspect of the present invention is a method for forming an image comprising: exposing the photothermographic material according to the second aspect to a radiation source and developing said photothermographic material, wherein said photothermographic material is developed by heating for 3 to 13 seconds.

Further, sixth to twentieth aspects of the present invention are described below as embodiments of the present invention.

A sixth aspect of the present invention is the photothermographic material according to the first aspect, further comprising a development accelerator.

A seventh aspect of the present invention is the photothermographic material according to the first aspect, wherein said non-photosensitive organic silver salt comprises silver behenate in an amount of 50% by mole or more.

A eighth aspect of the present invention is the photothermographic material according to the second aspect, wherein said non-photosensitive organic silver salt comprises silver behenate in an amount of 50% by mole or more.

A ninth aspect of the present invention is the photothermographic material according to the sixth aspect, wherein said non-photosensitive organic silver salt comprises silver behenate in an amount of 50% by mole or more.

A tenth aspect of the present invention is the photothermographic material according to the first aspect, wherein a coating liquid for forming said photothermographic material comprises an organic solvent.

A eleventh aspect of the present invention is the photothermographic material according to the tenth aspect, wherein said binder comprises a polyvinyl acetal.

A twelfth aspect of the present invention is the photothermographic material according to the first aspect, wherein a coating amount of silver is 1 g/m² to 1.9 g/m².

A thirteenth aspect of the present invention is the photothermographic material according to the second aspect, wherein a coating liquid for forming said photothermographic material comprises an organic solvent.

A fourteenth aspect of the present invention is the photothermographic material according to the thirteenth aspect, wherein said binder comprises a polyvinyl acetal.

A fifteenth aspect of the present invention is the photothermographic material according to the second aspect, wherein a coating amount of silver is 1 g/m² to 1.9 g/m².

A sixteenth aspect of the present invention is the photothermographic material according to the third aspect, wherein a coating liquid for forming said photothermographic material comprises an organic solvent.

A seventeenth aspect of the present invention is the photothermographic material according to the sixteenth aspect, wherein said binder comprises a polyvinyl acetal.

A eighteenth aspect of the present invention is the photothermographic material according to the third aspect, wherein a coating amount of silver is 1 g/m² to 1.9 g/m².

A ninteenth aspect of the present invention is a method for forming an image comprising: exposing the photothermographic material according to the second aspect to a radiation source; and developing the photothermographic material;

wherein the maximum density of the photothermographic material is 3.3 or more.

A twentieth aspect of the present invention is a method for forming an image comprising: exposing the photothermographic material according to the third aspect to a radiation source; and developing the photothermographic material;

wherein the maximum density of the photothermographic material is 3.3 or more.

As a result of intense research on the properties of unprocessed stock storability and image storability, the inventors have found that the glass-transition temperature of the binder contained in the image-forming layer significantly affects these properties. Further, as a result of the research, the inventors have derived the fact that the glass-transition temperature of the binder is preferably 70° C. to 110° C., from the relationship of these properties to other properties of the output image such as image quality and sensitivity.

However, the development activity of the photothermographic material was reduced in the case of using the binder having such a high glass-transition temperature. Therefore, it was required to develop technologies for increasing the development activity without deterioration of the unprocessed stock storability and the printout properties.

Various technologies for increasing the development activity have been known. The inventors have found that the development activity can be effectively increased in the present invention by using the reducing agent represented by general formula (R) or by adding the development accelerator, and the present invention has been completed based on this finding.

The photothermographic material contains all components required for forming an image. Performance requirements of high image quality, high sensitivity, high development activity, storage stability, film strength, coating workability, etc. cannot be satisfied only by changing a portion of compositions of the photothermographic material. In the present invention, the storage stability is increased not only by changing a portion of the compositions, but also by selecting the compositions in view of the relationships therebetween.

In the present invention, an unexpected effect of improving conveyability was obtained by combining the development accelerator or the reducing agent represented by general formula (R) with the binder having a particular glass-transition temperature.

The present invention is described in detail below.

1. Binder

The binder used in the image-forming layer of the photothermographic materials according to the present invention has the glass-transition temperature (hereinafter referred to as Tg) of 70 to 110° C. Tg of the binder is preferably 70 to 100° C., and more preferably 70 to 90° C. In the case of using a blend of a plurality of polymers having different Tg, it is preferred that the weight average Tg of the blend is within the above range.

Two or more polymers may be combined and used as the binder if necessary. In this case, two or more polymers having different Tg may be blended and used as the binder.

In the present invention, Tg is calculated using the following equation:

1 /Tg=Σ(Xi/Tgi)

Here the polymer is formed by copolymerization of n monomers of i=1 to n. Xi is the weight fraction of the ith monomer (ΣXi=1), and Tgi is the glass-transition temperature (absolute temperature) of the homopolymer of the ith monomer. Σ(Xi/Tgi) is the sum of Xi/Tgi for i=1 to n. It should be noted that the glass-transition temperature Tgi of the homopolymer of each monomer is such as described in J. Brandrup and E. H. Immergut, Polymer Handbook, 3rd Edition (Wiley-Interscience, 1989).

The binder used for the photothermographic materials of the present invention has Tg of 70 to 110° C., a number average molecular weight of 1,000 to 1,000,000, and preferably 10,000 to 500,000, and a polymerization degree of approximately 50 to 1,000. Examples of such binders include polymers and copolymers containing a unit derived from an unsaturated ethylene monomer such as vinyl chloride, vinyl acetate, vinyl alcohol, maleic acid, acrylic acid, acrylic ester, vinylidene chloride, acrylonitrile, methacrylic acid, methacrylic ester, styrene, butadiene, ethylene, vinyl butyral, vinyl acetal, and vinyl ether. Examples of the binders further include polyurethane resins, gum resins, phenol resins, epoxy resins, cured polyurethane resins, urea resins, melamine resins, alkyd resins, formaldehyde resins, silicone resins, epoxy-polyamide resins, polyester resins, etc. The resins are described in detail in Plastic Handbook, Asakura Shoten. These polymers are not particularly restricted and may be a homopolymer or a copolymer as long as they have a glass-transition temperature (Tg) of 70 to 110° C.

The polymers or copolymers containing a unit derived from the unsaturated ethylene monomer may be an alkyl acrylate, an aryl acrylate, an alkyl methacrylate, an aryl methacrylate, an alkyl cyanoacrylate, or an aryl cyanoacrylate. The alkyl groups and the aryl groups of the monomers may be substituted or unsubstituted, and specific examples thereof include a methyl group, an ethyl group, a n-propyl group, an isopropyl group, a n-butyl group, an isobutyl group, a sec-butyl group, a tert-butyl group, an amyl group, a hexyl group, a cyclohexyl group, a benzyl group, a chlorobenzyl group, an octyl group, a stearyl group, a sulfopropyl group, an N-ethyl-phenylaminoethyl group, a 2-(3-phenylpropyloxy)ethyl group, a dimethylaminophenoxyethyl group, a furfuryl group, a tetrahydrofurfuryl group, a phenyl group, a cresyl group, a naphtyl group, a 2-hydroxyethyl group, a 4-hydroxybutyl group, a triethylene glycol group, a dipropylene glycol group, a 2-methoxyethyl group, a 3-methoxybutyl group, a 2-acetoxyethyl group, a 2-acetoacetoxyethyl group, a 2-ethoxyethyl group, a 2-isopropoxyethyl group, a 2-butoxyethyl group, a 2-(2-methoxyethoxy)ethyl group, a 2-(2-ethoxyethoxy)ethyl group, a 2-(2-butoxyethoxy)ethyl group, a 2-diphenylphosphorylethyl group, a ω-methoxy polyethylene glycol group (addition mole number n=6), an allyl group, a dimethylaminoethylmethyl chloride group, etc. Examples of the monomers further include vinyl esters such as vinyl acetate, vinyl propionate, vinyl butyrate, vinyl isobutyrate, vinyl caproate, vinyl chloroacetate, vinyl methoxyacetate, vinyl phenylacetate, vinyl benzoate, and vinyl salicylate; N-substituted acrylamides, N-substituted methacrylamides, acrylamide, and methacrylamide, the N-substituent being a methyl group, an ethyl group, a propyl group, a butyl group, a tert-butyl group, a cyclohexyl group, a benzyl group, a hydroxymethyl group, a methoxyethyl group, a dimethylaminoethyl group, a phenyl group, a dimethyl group, a diethyl group, β-cyanoethyl group, an N-(2-acetoacetoxyethyl) group, a diacetone group, etc.; olefins such as dicyclopentadiene, ethylene, propylene, 1-butene, 1-pentene, vinyl chloride, vinylidene chloride, isoprene, chloroprene, butadiene, and 2,3-dimethylbutadiene; styrenes such as methylstyrene, dimethylstyrene, trimethylstyrene, ethylstyrene, isopropylstyrene, tert-butylstyrene, chloromethylstyrene, methoxystyrene, acetoxystyrene, chlorostyrene, dichlorostyrene, bromostyrene, and methyl vinylbenzoate; vinyl ethers such as methyl vinyl ether, butyl vinyl ether, hexyl vinyl ether, methoxyethyl vinyl ether, and dimethylaminoethyl vinyl ether; N-substituted maleimides, the N-substituent being a methyl group, an ethyl group, a propyl group, a butyl group, a tert-butyl group, a cyclohexyl group, a benzyl group, a n-dodecyl group, a phenyl group, a 2-methylphenyl group, a 2,6-diethylphenyl group, a 2-chlorophenyl group, etc.; and other monomers such as butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methyl vinyl ketone, phenyl vinyl ketone, methoxyethyl vinyl ketone, glycidyl acrylate, glycidyl methacrylate, N-vinyloxazolidone, N-vinylpyrrolidone, acrylonitrile, methacrylonitrile, methylene malononitrile, and vinylidene chloride.

Among the monomers, particularly preferred are alkyl methacrylates, aryl methacrylates, and styrenes. The binder is preferably a polymer having an acetal group, which is excellent in miscibility to an organic acid and thereby can effectively prevent the softening of the film.

In the present invention, it is preferable that the binder is a polyvinyl acetal substantially having an acetoacetal structure. Examples of such polyvinyl acetals are described in U.S. Pat. Nos. 2,358,836, 3,003,879, and 2,828,204, British Patent No. 771,155, etc.

The polymer having an acetal group is particularly preferably a compound represented by the following general formula (V).

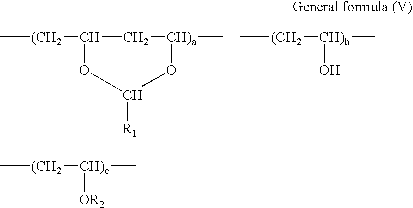

In general formula (V), R₁ represents an unsubstituted alkyl group, a substituted alkyl group, an unsubstituted aryl group, or a substituted aryl group. R₁ is preferably an unsubstituted alkyl group or a substituted alkyl group. R₂ represents an unsubstituted alkyl group, a substituted alkyl group, an unsubstituted aryl group, a substituted aryl group, —COR₃, or —CONHR₃. R₃ has the same meanings as R₁.

The unsubstituted alkyl group represented by R₁, R₂, or R₃ preferably has a carbon number of 1 to 20, and particularly preferably has a carbon number of 1 to 6. The unsubstituted alkyl group may be straight or branched, and preferably a straight alkyl group. Examples of the unsubstituted alkyl groups include a methyl group, an ethyl group, a n-propyl group, an isopropyl group, a n-butyl group, an isobutyl group, a t-butyl group, a n-amyl group, a t-amyl group, a n-hexyl group, a cyclohexyl group, a n-heptyl group, a n-octyl group, a t-octyl group, a 2-ethylhexyl group, a n-nonyl group, a n-decyl group, a n-dodecyl group, a n-octadecyl group, etc. The unsubstituted alkyl group is particularly preferably a methyl group or a propyl group.

The unsubstituted aryl group preferably has a carbon number of 6 to 20, and may be a phenyl group, a naphtyl group, etc. Examples of the substituents of the substituted alkyl groups and the substituted aryl groups include alkyl groups such as a methyl group, a n-propyl group, a t-amyl group, a t-octyl group, a n-nonyl group, and a dodecyl group; aryl groups such as a phenyl group; a nitro group; a hydroxyl group; a cyano group; a sulfo group; alkoxy groups such as a methoxy group; aryloxy groups such as a phenoxy group; acyloxy groups such as an acetoxy group; acylamino groups such as an acetylamino group; sulfonamide groups such as a methanesulfonamide group; sulfamoyl groups such as a methylsulfamoyl group; halogen atoms such as a fluorine atom, a chlorine atom, and a bromine atom; a carboxy group; carbamoyl groups such as a methyl carbamoyl group; alkoxycarbonyl groups such as a methoxycarbonyl group; sulfonyl groups such as a methylsulfonyl group; etc. In the case where the substituted alkyl or aryl group has two or more substituents, the substituents may be the same or different groups. The substituted alkyl group preferably has a total carbon number of 1 to 20, and the substituted aryl group preferably has a total carbon number of 6 to 20.

R₂ is preferably —COR₃ (in which R₃ is preferably an alkyl group or an aryl group) or —CONHR₃ (in which R₃ is preferably an aryl group).

In general formula (V), a, b, and c are values indicating the mole ratio (% by mole) of each repeating unit. The sum of a, b, and c is 100% by mole, a being 40 to 86% by mole, b being 0 to 30% by mole, and c being 0 to 60% by mole. It is particularly preferred that a is 50 to 86% by mole, b is 5 to 25% by mole, and c is 0 to 40% by mole. In the polymer represented by general formula (V), a plurality of R₁'s may be the same or different groups, and a plurality of R₂'s may be the same or different groups.

The polyurethane resin used in the present invention may have a known structure of polyester-polyurethane, polyether-polyurethane, polyether-polyester-polyurethane, polycarbonate-polyurethane, polyester-polycarbonate-polyurethane, polycaprolactone-polyurethane, etc. It is preferred that at least one polar group is introduced to the polyurethane resin by copolymerization or addition reaction. The polar group may be —COOM, —SO₃M, —OSO₃M, —P═O(OM)₂, —O—P═O(OM)₂—NR₂, —N⁺R₂, an epoxy group, —SH, —CN, etc., in which M represents a hydrogen atom or an alkaline metal atom, and R₂ represents a hydrocarbon group. The amount of the polar group in the polyurethane resin is 10⁻⁸ to 10⁻¹ mol/g, and preferably 10⁻⁶ to 10⁻² mol/g. The polyurethane resin preferably has two or more OH groups, such that at least one OH group is disposed at each end of the polyurethane chain, in addition to the polar groups. The OH group can be cross-linked to a curing agent of polyisocyanate to form a three-dimensional network structure. Thus, the more OH groups the polyurethane resin has, the more preferable. In particular, the polyurethane resin preferably has more OH groups at the ends of the polyurethane chain, because the OH groups disposed at the ends show higher reactivity to the curing agent. The polyurethane resin preferably has 3 or more OH groups at the ends, and particularly preferably has 4 or more OH groups at the ends. It is preferred that the polyurethane resin used in the present invention shows a glass-transition temperature of 70 to 110° C., a breaking elongation of 100 to 2,000%, and a rupture stress of 0.5 to 100 N/mm².

The polymers represented by general formula (V) can be synthesized by common synthesis methods described in Ichiro Sakurada, Sakusan Biniru Jushi (Vinyl Acetate Resin), Kobunshi Kagaku Kankokai, 1962, etc. A typical example of the synthesis method is described below without intention of restricting the scope of the present invention.

### SYNTHESIS EXAMPLE 1

### Synthesis of P-1

20 g of polyvinyl alcohol GOSENOL GH18 available from NIPPON GOSEI Co., Ltd. was dispersed in 180 g of pure water to obtain a dispersion containing 10% by mass of the polyvinyl alcohol. The dispersion was heated at 95° C. to dissolve the polyvinyl alcohol, and cooled to 75° C. to prepare an aqueous polyvinyl alcohol solution. Then, 1.6 g of 10% by mass hydrochloric acid solution as an acid catalyst was added to the aqueous polyvinyl alcohol solution, to obtain a dropping solution A. 11.5 g of a mixture of butylaldehyde and acetoaldehyde in a molar ratio of 1:1 was prepared as a dropping solution B. 100 ml of pure water was put in a 1000 ml four-necked flask equipped with a cooling tube and a stirring device, and strongly stirred at 85° C. The dropping solutions A and B were simultaneously added thereto dropwise over 2 hours by a dropping funnel with a temperature of 75° C. while stirring. Thus, the reaction was carried out while preventing coagulation of precipitates by controlling the stirring rate. After the addition, 7 g of a 10% by mass hydrochloric acid solution was added thereto as an acid catalyst, and stirred at 85° C. for 2 hours to complete the reaction. Then, the reaction mixture was cooled to 40° C., neutralized with sodium bicarbonate, washed with water five times, and filtered to separate a polymer product. The polymer product was dried to obtain P-1. The obtained P-1 was measured with respect to Tg by a differential scanning calorimeter DSC, and as a result, Tg of P-1 was 75° C.

The polymers shown in Table 1 were synthesized in a similar manner. The polymers may be used singly or as a blend of 2 or more compounds. In the photosensitive silver salt-containing layer (the image-forming layer), the polymer represented by general formula (V) is preferably used as a main binder. The main binder is such that the mass ratio of the main binder to the total mass of all the binders contained in the image-forming layer is 50% by mass or more. Thus, less than 50% by mass of other polymers may be blended with the main binder. The other polymers are not particularly limited as long as the main binder can be dissolved in a solvent. Examples of the preferred other polymers include polyvinyl acetates, polyacrylic resins, and urethane resins.

The polymers according to the present invention and comparative polymers are shown below. Tg's shown in the following table were measured by a differential scanning calorimeter (DSC) available from Seiko Instruments & Electronics Ltd.

| | a | | | b | c | |
|---|---|---|---|---|---|---|
| | Acetoacetal:Butyral | | Total Acetal | Hydroxyl Group | Acetyl | Tg |
| Polymer | (mol ratio) | | (% by mole) | (% by mole) | (% by mole) | (° C.) |
| P-1 | 6 | 4 | 73.7 | 24.6 | 1.7 | 85 |
| P-2 | 3 | 7 | 75.0 | 23.4 | 1.6 | 75 |
| P-3 | 10 | 0 | 73.6 | 24.5 | 1.9 | 110 |
| P-5 | 7 | 3 | 71.1 | 27.3 | 1.6 | 88 |
| P-6 | 10 | 0 | 73.3 | 24.8 | 1.9 | 104 |
| P-7 | 10 | 0 | 73.5 | 24.6 | 1.9 | 104 |
| P-8 | 3 | 7 | 74.4 | 24.0 | 1.6 | 75 |
| P-9 | 3 | 7 | 75.4 | 23.0 | 1.6 | 74 |
| Comparative | — | — | — | — | — | 65 |
| Polymer 1 | | | | | | |
| Comparative | — | — | — | 53.0 | 2.0 | 131 |
| Polymer 2 | | | | | | |

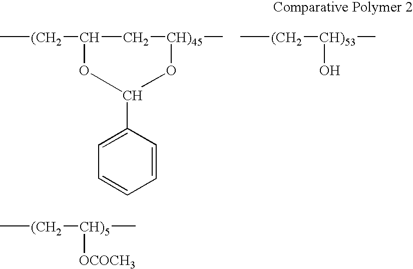

Comparative Polymer 1 is B-79 (Butuvar Available from Monsanto Company).

The image-forming layer particularly preferably contains a polyvinyl butyral as the binder. Specifically, the mass ratio of the polyvinyl butyral to the total mass of all the binders contained in the image-forming layer is particularly preferably 50% by mass or more. The polyvinyl butyral may be a copolymer or a terpolymer. The mass ratio of the polyvinyl butyral is preferably 50 to 100% by mass, and more preferably 70 to 100% by mass, based on the total mass of all the binders contained in the image-forming layer.

The amount of the binder is determined, for example, such that the binder can maintain the components in the image-forming layer. Thus, the amount is determined such that the binder can effectively act to bind the components. The amount can be suitably determined by one skilled in the art. In the case of using the binder for maintaining at least the organic silver salt, the mass ratio of the binder/the organic silver salt is preferably 15/1 to 1/3, and particularly preferably 8/1 to 1/2.

2. Coating Solvent

Examples of the solvents usable in the present invention include ones described in Solvent Pocketbook, New Edition, Ohmsha, Ltd., 1994, though the present invention is not restricted by the examples. The boiling point of the solvent is preferably 40 to 180° C. The solvent is preferably an organic solvent though water may be used as the solvent. Specific examples of the organic solvents include hexane, cyclohexane, toluene, methanol, ethanol, isopropanol, acetone, methyl ethyl ketone, ethyl acetate, 1,1,1-trichloroethane, tetrahydrofuran, triethylamine, thiophene, trifluoroethanol, perfluoropentane, xylene, n-butanol, phenol, methyl isobutyl ketone, cyclohexanone, butyl acetate, diethyl carbonate, chlorobenzene, dibutyl ether, anisole, ethylene glycol diethyl ether, N,N-dimethylformamide, morpholine, propanesultone, perfluorotributylamine, etc. Among the organic solvents, methyl ethyl ketone is preferred because it has a suitable boiling point and can be easily dried to obtain a uniform application surface with a less residual solvent.

The amount of the solvent remaining in the resultant layer after the application and drying is preferably reduced as much as possible. The residual solvent is generally volatilized in the step of exposing or heat-developing the photothermographic material to give uncomfortable impression and health problems.

In the case of using MEK as the solvent in the present invention, the amount of the residual solvent is preferably 0.1 mg/m² to 150 mg/m², and more preferably 0.1 mg/m² to 80 mg/m², and furthermore preferably 0.1 mg/m² to 40 mg/m².

3. Reducing Agent

The photothermographic materials of the present invention contain the reducing agent for the organic silver salt. The reducing agent may be any substance that can reduce a silver ion into metallic silver, and preferably an organic substance. Examples of the reducing agents are described in JP-A No. 11-65021, paragraphs 0043 to 0045; EP No. 0803764, page 7, line 34 to page 18, line 12; etc.

In the present invention, the reducing agent is preferably a so-called hindered phenol reducing agent having a substituent at an ortho position of the phenolic hydroxyl group, or a bisphenol reducing agent, and more preferably a bisphenol reducing agent, and particularly preferably a compound represented by the following general formula (R).

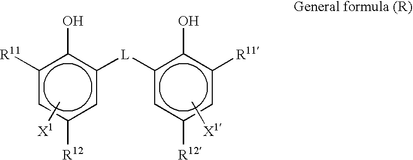

In general formula (R), R¹¹ and R^{11′} each independently represents a secondary or tertiary alkyl group having a carbon number of 3 to 15 in the case where the compound of general formula (R) is used in the photothermographic material containing no development accelerator. In the case of using the compound of general formula (R) in the photothermographic material containing a development accelerator, R¹¹ and R^{11′} each independently represents an alkyl group having a carbon number of 1 to 20. R¹² and R^{12′} each independently represents a hydrogen atom or a substituent bondable to the benzene ring. L represents a —S— group or a —CHR¹³— group, and R¹³ represents a hydrogen atom or an alkyl group having a carbon number of 1 to 20. X¹ and X^{1′} each independently represents a hydrogen atom or a substituent bondable to the benzene ring.

The components of the compound represented by general formula (R) are described in detail below.

1) R¹¹ and R^{11′}

In the case of using the compound of general formula (R) in the photothermographic materials containing a development accelerator, R¹¹ and R^{11′} are each independently represents a substituted or unsubstituted alkyl group having a carbon number of 1 to 20. The substituent on the alkyl group is preferabiy an aryl group, a hydroxy group, an alkoxy group, an aryloxy group, an alkylthio group, an arylthio group, an acylamino group, a sulfonamide group, a sulfonyl group, a phosphoryl group, an acyl group, a carbamoyl group, an ester group, or a halogen atom, though there are no particular restrictions therein.

In the case of using the compound of general formula (R) in the photothermographic materials containing no development accelerator, R¹¹ and R^{11′} are each independently represents a secondary or tertiary alkyl group having a carbon number of 3 to 15. Specific examples of the secondary or tertiary alkyl groups include an isopropyl group, an isobutyl group, a t-butyl group, a t-amyl group, a t-octyl group, a cyclohexyl group, a cyclopentyl group, a 1-methylcyclohexyl group, a 1-methylcyclopropyl group, etc.

2) R¹² and R^{12′}, and X¹ and X^{1′}

R¹² and R^{12′} each independently represents a hydrogen atom or a substituent bondable to the benzene ring. X¹ and X^{1′} each independently represents a hydrogen atom or a substituent bondable to the benzene ring. Examples of the preferred substituents bondable to the benzene ring include alkyl groups, aryl groups, halogen atoms, alkoxy groups, and acylamino groups.

3) L

L represents a —S— group or a —CHR¹³— group. R¹³ represents a hydrogen atom or an alkyl group having a carbon number of 1 to 20, and the alkyl group may have a substituent.

Specific examples of the unsubstituted alkyl groups represented by R¹³ include a methyl group, an ethyl group, a propyl group, a butyl group, a heptyl group, an undecyl group, an isopropyl group, a 1-ethylpentyl group, a 2,4,4-trimethylpentyl group, etc.

Specific examples of the substituents on the alkyl group represented by R¹³, which may be the same as those of the substituents on R¹¹ or R^{11′}, include a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group, a sulfamoyl group, etc.

4) Preferred Substituents

R¹¹ and R^{11′} are preferably a secondary or tertiary alkyl group having a carbon number of 3 to 15 respectively also in the case of using the compound of general formula (R) in the photothermographic materials containing a development accelerator. Specific examples of the secondary or tertiary alkyl groups include an isopropyl group, an isobutyl group, a t-butyl group, a t-amyl group, a t-octyl group, a cyclohexyl group, a cyclopentyl group, a 1-methylcyclohexyl group, a 1-methylcyclopropyl group, etc.

R¹¹ and R^{11′} are more preferably a tertiary alkyl group having a carbon number of 4 to 12, and furthermore preferably a t-butyl group, a t-amyl group, or a 1-methylcyclohexyl group, and the most preferably a t-butyl group, respectively.

R¹² and R^{12′} are preferably an alkyl group having a carbon number of 1 to 20 respectively, and specific examples thereof include a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group, etc. R¹² and R^{12′} are more preferably a methyl group, an ethyl group, a propyl group, an isopropyl group, or a t-butyl group, respectively.

X¹ and X^{1′} are preferably a hydrogen atom, a halogen atom, or an alkyl group, and more preferably a hydrogen atom, respectively.

L is preferably a —CHR¹³— group, and R¹³ is preferably a hydrogen atom or an alkyl group having a carbon number of 1 to 15. Preferred as the alkyl group are a methyl group, an ethyl group, a propyl group, an isopropyl group, and a 2,4,4-trimethylpentyl group. R¹³ is particularly preferably a hydrogen atom, a methyl group, a propyl group, or an isopropyl group.

When R¹³ is a hydrogen atom, R¹² and R^{12′} are preferably an alkyl group having a carbon number of 2 to 5, and more preferably an ethyl group or a propyl group, and most preferably an ethyl group, respectively.

When R¹³ is a normal or secondary alkyl group having a carbon number of 1 to 8, R¹² and R12′ are preferably a methyl group. The normal or secondary alkyl group of R¹³ having a carbon number of 1 to 8 is preferably a methyl group, an ethyl group, a propyl group, or an isopropyl group, and more preferably a methyl group, an ethyl group, or a propyl group.

When all of R¹¹, R^{11′}, R¹² and R^{12′} are a methyl group, R¹³ is preferably a secondary alkyl group. In this case, the secondary alkyl group of R¹³ is preferably an isopropyl group, an isobutyl group, or a 1-ethylpentyl group, and more preferably an isopropyl group.

The heat developing properties of the reducing agent depend on the combination of R¹¹, R^{11′}, R¹², R^{12′} and R¹³. The heat developing properties can be controlled by combining 2 or more reducing agents, whereby it is preferable that 2 or more reducing agents are used in combination depending on the purpose.

Specific examples of the compounds represented by general formula (R) for the present invention are illustrated below without intention of restricting the scope of the present invention.

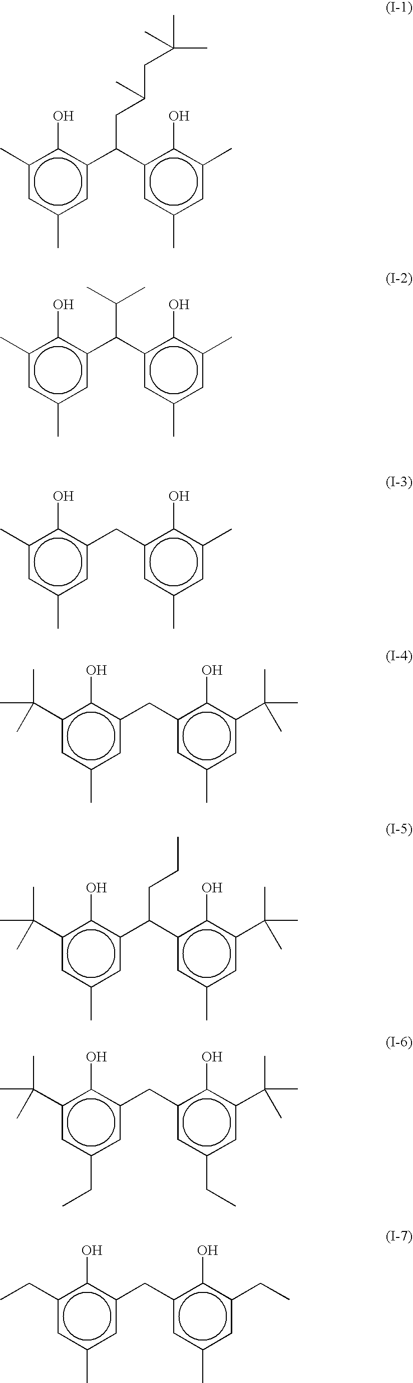

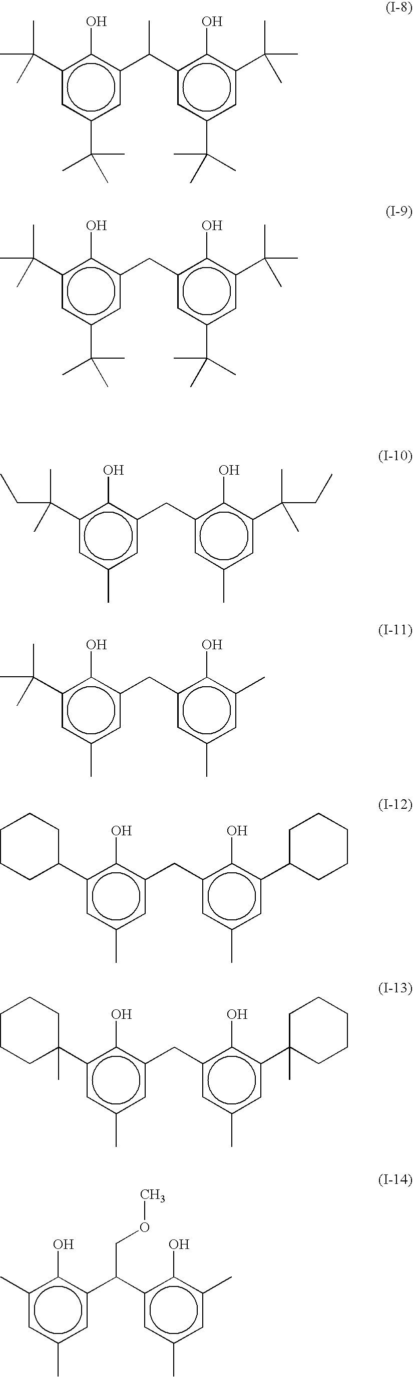

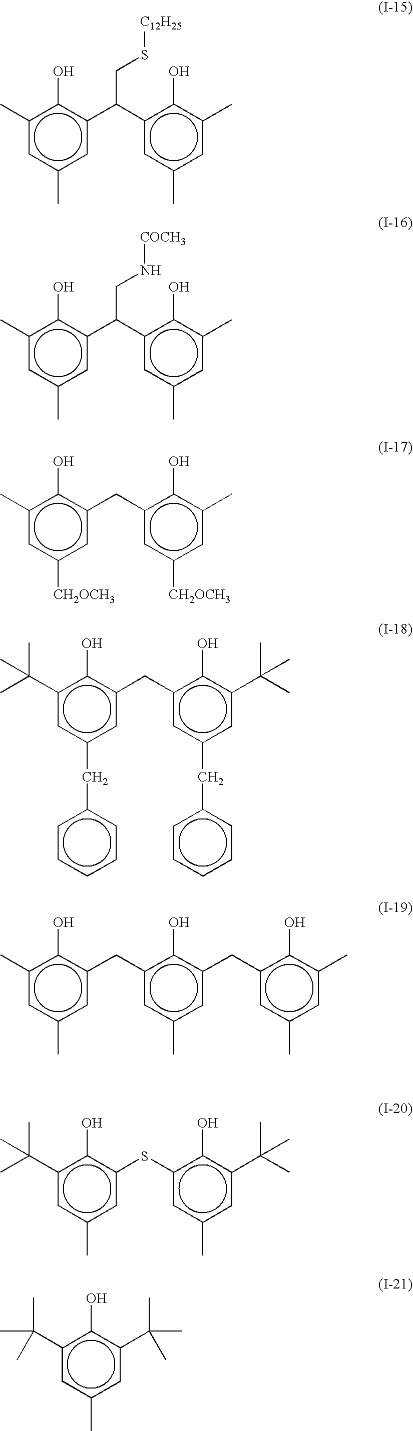

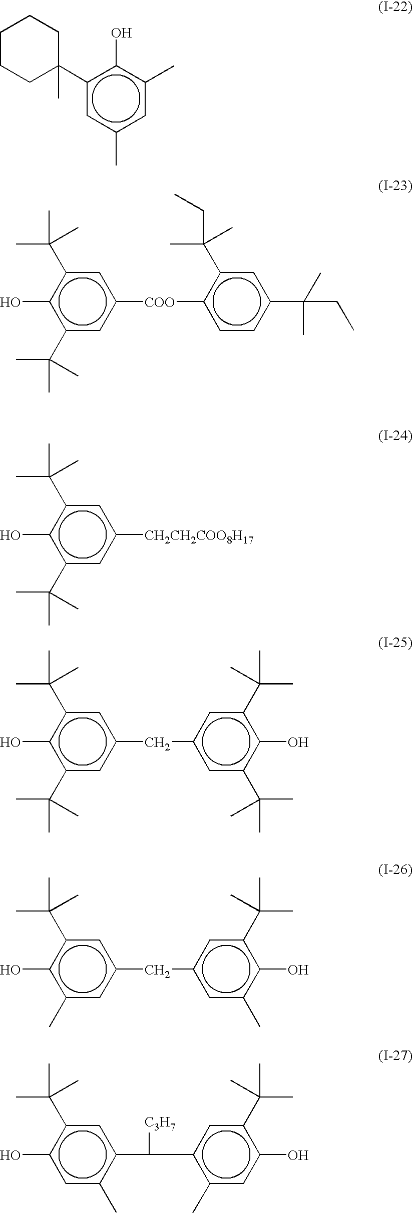

In the photothermographic materials without development accelerator, the compound of general formula (R) such as 1-4 to 1-6, I-8 to I-13, I-18, and I-20, in which R¹¹ and R^{11′} are each independently represents a secondary or tertiary alkyl group having a carbon number of 3 to 15, is used as the reducing agent.

The amount of the reducing agent is preferably 0.01 g/m² to 5.0 g/m², and more preferably 0.1 g/m² to 3.0 g/m². The mole ratio of the reducing agent to silver in the image-forming layer is preferably 5% by mole to 50% by mole, and more preferably 10% by mole to 40% by mole.

The reducing agent according to the present invention may be added to the image-forming layer containing the organic silver salt and the photosensitive silver halide, or a layer adjacent thereto. The reducing agent is preferably added to the image-forming layer.

The reducing agent may be added to the coating liquid as a solution, an emulsified dispersion, a solid fine particle dispersion, etc. It is preferred that the reducing agent is dissolved in the solvent for the coating liquid, and added to the photothermographic material as a solution.

4. Development Accelerator

According to one aspect of the present invention, the photothermographic material contains a development accelerator. Examples of the preferred development accelerators include sulfonamidephenol type compounds represented by general formula (A) described in JP-A Nos. 2000-267222 and 2000-330234; hindered phenol type compounds represented by general formula (II) described in JP-A No. 2001-92075; hydrazine type compounds represented by general formula (I) described in JP-A Nos. 10-62895 and 11-15116, general formula (D) described in JP-A No. 2002-156727, or general formula (1) described in JP-A No. 2002-278017; and phenol type compounds and naphthol type compounds represented by general formula (2) described in JP-A No. 2001-264929. The mole ratio of the development accelerator to the reducing agent is 0.1% by mole to 20% by mole, and preferably 0.5% by mole to 10% by mole, and more preferably 1% by mole to 5% by mole. The development accelerator may be added to the photothermographic material in the same manner as the reducing agent. It is preferred that the development accelerator is dissolved in an organic solvent and thus added to the photothermographic material.

In the present invention, the hydrazine type compounds represented by general formula (D) described in JP-A No.2002-156727, and the phenol type compounds and naphthol type compounds represented by general formula (2) described in JP-A No. 2001-264929 are more preferably used as the development accelerator.

The development accelerator used in the present invention is particularly preferably represented by following general formula (A-1) or (A-2).

Q1-NHNH-Q2 General Formula (A-1)

In general formula (A-1), Q1 represents a heterocyclic group or an aromatic group having a carbon atom bonding to the —NHNH-Q2 group, and Q2 represents a carbamoyl group, an acyl group, an alkoxycarbonyl group, an aryloxycarbonyl group, a sulfonyl group, or a sulfamoyl group.

In general formula (A-1), the aromatic group and the heterocyclic group represented by Q1 preferably has a 5- to 7-membered unsaturated ring. Examples of the preferred 5- to 7-membered unsaturated rings include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isoxazole ring, a thiophene ring, and condensed rings thereof.

These rings may have a substituent. The rings may have 2 or more substituents, which may be the same or different substituents. Examples of such substituents include halogen atoms, alkyl groups, aryl groups, carbonamide groups, alkylsulfonamide groups, arylsulfonamide groups, alkoxy groups, aryloxy groups, alkylthio groups, arylthio groups, carbamoyl groups, sulfamoyl groups, a cyano group, alkylsulfonyl groups, arylsulfonyl groups, alkoxycarbonyl groups, aryloxycarbonyl groups, and acyl groups. These substituents may further have a substituent, and preferred examples thereof include halogen atoms, alkyl groups, aryl groups, carbonamide groups, alkylsulfonamide groups, arylsulfonamide groups, alkoxy groups, aryloxy groups, alkylthio groups, arylthio groups, acyl groups, alkoxycarbonyl groups, aryloxycarbonyl groups, carbamoyl groups, a cyano group, sulfamoyl groups, alkylsulfonyl groups, arylsulfonyl groups, and acyloxy groups.

The carbamoyl group represented by Q2 preferably has a carbon number of 1 to 50, and more preferably has a carbon number of 6 to 40. Examples of the carbamoyl groups include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl) carbamoyl, N-phenylcarbamoyl, N-(4-dodecyloxyphenyl) carbamoyl, N-(2-chloro-5-dodecyloxycarbonylphenyl)carbamoyl, N-naphtylcarbamoyl, N-3-pyridylcarbamoyl, and N-benzylcarbamoyl groups.

The acyl group represented by Q2 preferably has a carbon number of 1 to 50, and more preferably has a carbon number of 6 to 40. Examples of the acyl groups include formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl groups.

The alkoxycarbonyl group represented by Q2 preferably has a carbon number of 2 to 50, and more preferably has a carbon number of 6 to 40. Examples of the alkoxycarbonyl groups include methoxycarbonyl, ethoxycarbonyl, isobutyloxycarbonyl, cyclohexyloxycarbonyl, dodecyloxycarbonyl, and benzyloxycarbonyl groups.

The aryloxycarbonyl group represented by Q2 preferably has a carbon number of 7 to 50, and more preferably has a carbon number of 7 to 40. Examples of the aryloxycarbonyl groups include phenoxycarbonyl, 4-octyloxyphenoxycarbonyl, 2-hydroxymethylphenoxycarbonyl, and 4-dodecyloxyphenoxycarbonyl groups.

The sulfonyl group represented by Q2 preferably has a carbon number of 1 to 50, and more preferably has a carbon number of 6 to 40. Examples of the sulfonyl groups include methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl groups.

The sulfamoyl group represented by Q2 preferably has a carbon number of 0 to 50, and more preferably has a carbon number of 6 to 40. Examples of the sulfamoyl groups include unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl groups.

The group of Q2 may have a substituent, which may be the same as the substituent on the 5- to 7-membered unsaturated ring of Q1. The group of Q2 may have 2 or more substituents, which may be the same or different.

Preferred embodiments of the compound represented by general formula (A-1) are described below. Q1 preferably has a 5-or 6-membered unsaturated ring, and more preferably has a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isoxazole ring, or a condensed ring of a benzene ring or an unsaturated heterocycle condensed therewith. Q2 is preferably a carbamoyl group, and particularly preferably a carbamoyl group having a hydrogen atom on the nitrogen atom.

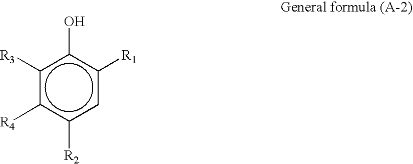

In general formula (A-2), R₁ represents an alkyl group, an acyl group, an acylamino group, a sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group, or a carbonic acid ester group. R₃ and R₄ each independently represents a substituent linkable to the benzene ring, and examples thereof may be the same as the examples of the substituents on the ring in general formula (A-1). R₃ and R₄ may bond together to form a condensed ring.

R₁ is preferably an alkyl group having a carbon number of 1 to 20 such as a methyl group, an ethyl group, an isopropyl group, a butyl group, a tert-octyl group, and a cyclohexyl group; an acylamino group such as an acetylamino group, a benzoylamino group, a methylureido group, and a 4-cyanophenylureido group; or a carbamoyl group such as a n-butylcarbamoyl group, an N,N-diethylcarbamoyl group, a phenylcarbamoyl group, a 2-chlorophenylcarbamoyl group, and a 2,4-dichlorophenylcarbamoyl group. More preferred as R₁ are acylamino groups including ureido groups and urethane groups.

R₂ is preferably a halogen atom (more preferably a chlorine atom or a bromine atom); an alkoxy group such as a methoxy group, a butoxy group, a n-hexyloxy group, a n-decyloxy group, a cyclohexyloxy group, and a benzyloxy group; or an aryloxy group such as a phenoxy group and a naphthoxy group.

R₃ is preferably a hydrogen atom, a halogen atom, or an alkyl group having a carbon number of 1 to 20, and most preferably a halogen atom. R₄ is preferably a hydrogen atom, an alkyl group, or an acylamino group, and more preferably an alkyl group or an acylamino group. Preferred examples of the groups may be the same as those of R₁. When R₄ is an acylamino group, it is also preferred that R₄ and R₃ bond together to form a carbostyryl ring.

In the case where a condensed ring is formed by R₃ and R₄ bonding together in general formula (A-2), the condensed ring is particularly preferably a naphthalene ring. The naphthalene ring may have a substituent with examples equal to those of the substituent on the ring in general formula (A-1). In the case where the compound represented by general formula (A-2) is a naphthol type compound, R₁ is preferably a carbamoyl group, and particularly preferably a benzoyl group. R₂ is preferably an alkoxy group or an aryloxy group, and particularly preferably an alkoxy group.

Specific examples of the preferred development accelerators used in the present invention are illustrated below without intention of restricting the scope of the present invention.

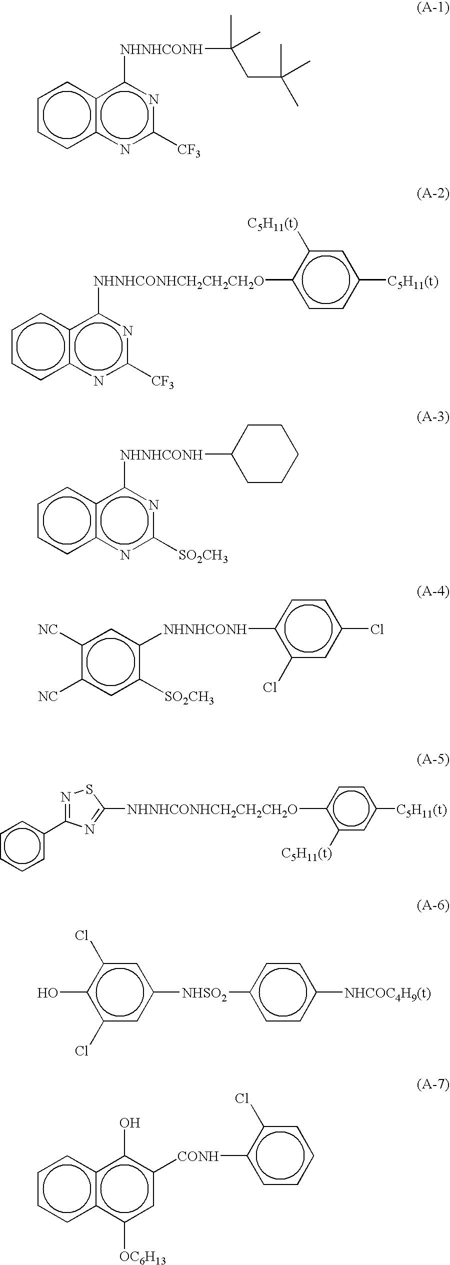

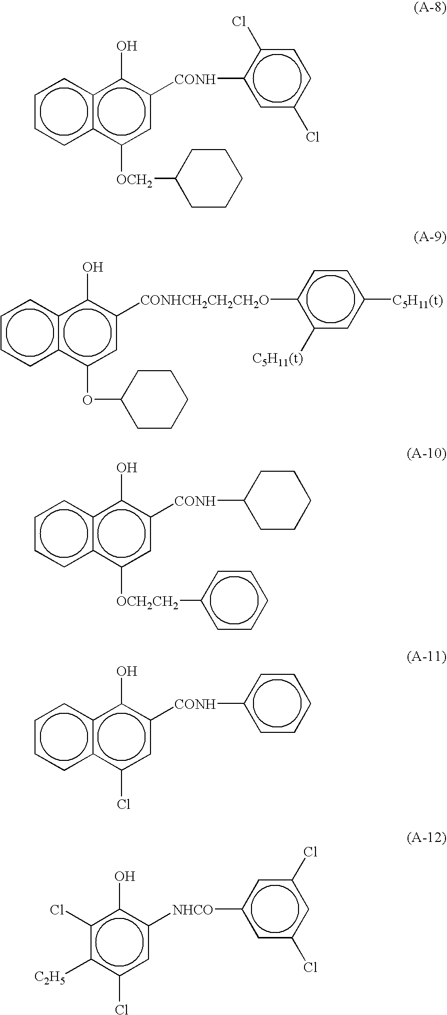

5. Photosensitive Silver Halide

1) Halogen Composition

The halogen composition of the photosensitive silver halide used for the present invention is not particularly restricted, and may comprise silver chloride, silver chlorobromide, silver bromide, silver iodobromide, silver iodochlorobromide, silver iodide, etc. Among them, silver bromide and silver iodobromide are preferable. In grains of the photosensitive silver halide, the halogen composition may be uniformly distributed, or changed stepwise or continuously. Further, photosensitive silver halide grains having a core-shell structure are also preferably used in the present invention. The core-shell grains preferably have 2- to 5-layered structure, and more preferably have 2- to 4-layered structure. Silver chloride, silver chlorobromide, silver bromide, silver iodobromide, silver iodochlorobromide, or silver iodide, etc. may be localized in the photosensitive silver halide grains.

2) Grain Size

When the size of the photosensitive silver halide grain is too large, the transparency of the film is reduced after forming an image. The photosensitive silver halide grain size is preferably 0.20 μm or less, and more preferably 0.01 to 0.15 μm, and furthermore preferably 0.02 to 0.12 μm. The photosensitive silver halide grain size is the average diameter of circles equivalent to projected areas of the grains, which is obtained by observation using an electron microscope. In the case of tabular grains, projected area of the major face is used to obtain the average diameter.

3) Coating Amount

The amount of silver in the photosensitive silver halide applied may be 0.03 g/m² to 0.6 g/m², and preferably 0.05 g/m² to 0.4 g/m², and furthermore preferably 0.07 g/m² to 0.3 g/m². The amount of the photosensitive silver halide per 1 mol of silver in the non-photosensitive organic silver salt to be hereinafter described may be 0.01 mol to 0.5 mol, and preferably 0.02 mol to 0.3 mol, and more preferably 0.03 mol to 0.2 mol.

4) Method for Forming Photosensitive Silver Halide Grains

Methods for forming the photosensitive silver halide grains are well known in the field. For example, the methods described in Research Disclosure, No. 17029, June 1978 and U.S. Pat. No. 3,700,458 may be used in the present invention. Specifically, the photosensitive silver halide may be prepared by adding a silver source and a halogen source to a solution of gelatin or another polymer, and by mixing the resultant with an organic silver salt. Further, methods described in JP-A No. 11-119374, paragraphs 0217 to 0224, JP-A No. 11-352627, and JP-A No. 2000-347335 may be preferably used in the present invention.

For example, so-called halidation methods, in which silver in the organic silver salt is partly halogenated by an organic or inorganic halide, can be preferably used in the present invention. The organic halide for the halidation methods may be any compound that can react with the organic silver salt to produce a silver halide, and examples thereof include N-halogenoimides such as N-bromosuccinimide; halogenated quaternary nitrogen compounds such as tetrabutylammonium bromide; associations of halogenated quaternary nitrogen salts and halogen molecules such as pyridinium bromide perbromide; etc. The inorganic halide for the halidation methods may be any compound that can react with the organic silver salt to produce a silver halide, and examples thereof include alkaline metal halides and ammonium halides such as sodium chloride, lithium bromide, potassium iodide, and ammonium bromide; alkaline earth metal halides such as calcium bromide and magnesium chloride; transition metal halides such as ferric chloride and cupric bromide; metal complexes having halogen ligands such as sodium bromoiridate and ammonium chlororhodate; halogen molecules such as bromine, chlorine, and iodine molecules; etc. The organic or inorganic halides may be used in a desired combination. The amount of the organic or inorganic halides for the halidation methods is preferably such that the mole number of the halogen atoms in the halides is 1 to 500 mmol per 1 mol of the organic silver salt. The mole number is more preferably 10 to 250 mmol.

The photosensitive silver halide grain may be desalted by water-washing according to a method known in the art such as a noodle method and a flocculation method, though the grain may not be desalted.

5) Shape of Grains

The photosensitive silver halide grains may be cuboidal grains, octahedral grains, tetradecahedral grains, dodecahedral grains, tabular grains, spherical grains, rod-shape grains, potato-like grains, etc. Particularly preferred among them are dodecahedral grains, tetradecahedral grains, and tabular grains. The photosensitive silver halide grains having a high silver iodide content can be in a complicated shape, and are preferably conjugated grains or tabular grains as described in R. L. Jenkins, et al., J. Phot. Sci., Vol. 28 (1980), page 164, FIG. 1. Grains with roundish corners may be also preferably used in the present invention. The face index (Miller indices) of the outer surface plane of the photosensitive silver halide grain is not particularly limited. It is preferred that the silver halide grains have a higher proportion of [100] faces, because a spectrally sensitizing dye shows a higher spectral sensitization efficiency when adsorbed to the [100] faces. The proportion of the [100] faces is preferably 50% or more, and more preferably 65% or more, and further preferably 80% or more. The proportion of the [100] faces according to the Miller indices can be obtained by the method described in T. Tani, J. Imaging Sci., 29, 165 (1985) using the adsorption dependency between [111] face and [100] face upon adsorption of the sensitizing dye.

6) Heavy Metal

The photosensitive silver halide grains used in the present invention may contain a metal of Group 3 to 13 of the Periodic Table of Elements including Group 1 to 18, or a complex thereof. Preferred as the metal of Group 3 to 13 or a center metal of the metal complex are rhodium and ruthenium. The metal complex may be used singly or combined with other complexes containing the same or different metal. The amount of the metal or the complex thereof is preferably 1×10⁻⁹ mol to 1×10⁻³ mol per 1 mol of silver. The heavy metals, the metal complexes, and methods for adding them are described in JP-A No. 7-225449, JP-A No. 11-65021, paragraphs 0018 to 0024, and JP-A No. 11-119374, paragraphs 0227 to 0240.

In the present invention, it is preferred that a hexacyano metal complex is disposed on the outermost surface of the silver halide grain. Examples of the hexacyano metal complexes include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [Re(CN)₆]³⁻, etc. Hexacyano Fe complexes are preferably used in the present invention.

The counter cation of the hexacyano metal complex is not important because the hexacyano metal complex exists as an ion in an aqueous solution. It is preferred that the counter cation is highly miscible in water, and suitable for depositing the silver halide emulsion. Examples of the preferred counter cations include alkaline metal ions such as a sodium ion, a potassium ion, a rubidium ion, a cesium ion, and a lithium ion; and ammonium ions and alkylammonium ions such as a tetramethylammonium ion, a tetraethylammonium ion, a tetrapropylammonium ion, and a tetra-n-butylammonium ion.

The hexacyano metal complex may be added with water or solvent which water and water-miscible organic solvent (such as an alcohol, an ether, a glycol, a ketone, an ester, and an amide) are mixed. The hexacyano metal complex may be added as a mixture with gelatin.

The amount of the hexacyano metal complex added is preferably 1×10⁻⁵ mol to 1×10⁻² mol, and more preferably 1×10⁻⁴ mol to 1×10⁻³ mol, per 1 mol of silver.

To dispose the hexacyano metal complex on the outermost surface of the silver halide grain, the hexacyano metal complex may be directly added to the silver halide grain, before completing the preparation steps between the step of adding an aqueous silver nitrate solution for forming the grain and the chemical sensitization step of noble metal sensitization such as chalcogen sensitization (e.g. sulfur sensitization, selenium sensitization, tellurium sensitization, etc.) and gold sensitization; during the water-washing step; during the dispersion step; or before the chemical sensitization. It is preferable that the hexacyano metal complex is added rapidly after forming the grains before completing the preparation step to prevent the growth of the silver halide grains.

The hexacyano metal complex is added preferably after 96% by mass of the aqueous silver nitrate solution for forming the grain is added, and more preferably after 98% by mass of the aqueous silver nitrate solution is added, and particularly preferably after 99% by mass of the aqueous silver nitrate solution is added.

When the hexacyano metal complex is added immediately before the completion of the grain formation after the addition of the aqueous silver nitrate solution, the hexacyano metal complex is adsorbed onto the outermost surface of the silver halide grain, and mostly forms a hardly-soluble salt with a silver ion on the surface. This silver salt of hexacyano iron (II) is less soluble than AgI and thus can prevent remelting of the fine grains, whereby the silver halide grains with a smaller grain size can be produced.

Another metal atom that can be contained in the silver halide grains, and the desalination methods and the chemical sensitization methods for the silver halide emulsion usable in the present invention are described in JP-A No.11-84574, paragraphs 0046 to 0050, JP-A No. 11-65021, paragraphs 0025 to 0031, JP-A No. 11-119374, paragraphs 0242 to 0250, etc.

7) Gelatin

Various gelatins may be contained in the photosensitive silver halide emulsion used in the present invention. The gelatin needs to maintain the excellent dispersion of the photosensitive silver halide emulsion in the organic silver salt-containing coating liquid, and thus the gelatin is preferably a low-molecular-weight gelatin having a molecular weight of 10,000 to 1,000,000. Phthalated gelatins are also preferably used in the present invention. The gelatin is preferably used in the grain formation step though it may be used in the dispersion step after the desalting treatment.

8) Chemical Sensitization

It is preferred that the photosensitive silver halide grains are chemically sensitized by a sulfur sensitization method, a selenium sensitization method, or a tellurium sensitization method. Known compounds described in JP-A No. 7-128768, etc. may be preferably used in the sulfur sensitization method, the selenium sensitization method, and the tellurium sensitization method. In the present invention, the chemical sensitization method is preferably the tellurium sensitization method, and more preferably a sensitization method using a compound described in references in JP-A No. 11-65021, paragraph 0030, or a compound represented by general formula (II), (III), or (IV) described in JP-A No. 5-313284.

The amount of the sulfur, selenium, or tellurium sensitizer is generally 10⁻⁸ mol to 10⁻² mol, and preferably 10⁻⁷ mol to 10⁻³ mol, per 1 mol of the silver halide, though the amount may be selected depending on the silver halide grains, conditions for the chemical ripening, etc.

The photosensitive silver halide grains may be chemically sensitized by a gold sensitization method in addition to the above chalcogen sensitization methods. The gold sensitizer is preferably such that the valence of gold is +1 or +3. Typical examples of the preferable gold sensitizers include chloroauric acid, bromoauric acid, potassium chloroaurate, potassium bromoaurate, auric trichloride, potassium aurithiocyanate, potassium iodoaurate, tetracyanoauric acid, ammonium aurothiocyanate, pyridyltrichloro gold, etc. Further, gold sensitizers described in U.S. Pat. No. 5,858,637 and JP-A No. 2002-278016 are also preferably used in the present invention.

The amount of the gold sensitizer added is approximately preferably 10⁻⁷ mol to 10⁻³ mol, and more preferably 10⁻⁶ mol to 5×10⁻⁴ mol, per 1 mol of the silver halide, though the amount may be selected depending on various conditions.

In the present invention, the chemical sensitization may be carried out in any step between the grain formation step and the coating step, for example, (1) before the spectral sensitization step, (2) during the spectral sensitization step, (3) after the spectral sensitization step, or (4) immediately before the coating step, after the desalination step.

The conditions for the chemical sensitization are not particularly restricted, generally such that pH is 5 to 8, pAg is 6 to 11, and temperature is 40 to 95° C.

A thiosulfonic acid compound may be added to the silver halide emulsion by a method described in EP-A No. 293,917.

In the present invention, the photosensitive silver halide grains may be subjected to reduction sensitization. Ascorbic acid or thiourea dioxide is preferably used as the reduction sensitizer, and stannous chloride, aminoiminomethanesulfonic acid, a hydrazine derivative, a borane compound, a silane compound, or a polyamine compound, etc. is preferably used therewith. The reduction sensitizer may be added in any step between the crystal growth step and the coating step. The reduction sensitization is preferably achieved by ripening the emulsion while adjusting the pH of the emulsion to 7 or more and adjusting the pAg of the emulsion to 8.3 or less. Further, reduction sensitization may be preferably achieved by introducing a single addition part of silver ion in the grain formation step.

The photosensitive silver halide emulsion preferably contains an FED sensitizer (fragmentable electron donating sensitizer), which can generate 2 electrons by using 1 photon. The FED sensitizer is preferably a compound described in U.S. Pat. Nos. 5,747,235, 5,747,236, 6,054,260, and 5,994,051, and JP-A No. 2002-287293. The FED sensitizer is preferably added in any step during the period of from the crystal growth step to immediately before the coating step. The amount of the FED sensitizer added is approximately preferably 10⁻⁷ mol to 10⁻¹ mol, and more preferably 10⁻⁶ mol to 5×10⁻² mol, per 1 mol of the silver halide, though the amount may be selected depending on various conditions.

9) Sensitizing Dye

The sensitizing dye used in the present invention is adsorbed to the silver halide grains, whereby the grains are spectrally sensitized to a desired wavelength range. The sensitizing dye having a spectral sensitivity suitable for spectral characteristics of an exposure light source is advantageously used. It is preferred that the photothermographic materials of the present invention are spectrally sensitized to have a spectral sensitivity peak particularly within a range of 600 to 900 nm or 300 to 500 nm. The sensitizing dyes and methods for adding them are described in JP-A No. 11-65021 (paragraphs 0103 to 0109); JP-A No. 10-186572 (the compounds represented by general formula (II)); JP-A No. 11-119374 (the dyes represented by general formula (I) and paragraph 0106); U.S. Pat. No. 5,510,236; U.S. Pat. No. 3,871,887 (the dyes described in Example 5); JP-A No. 2-96131; JP-A No. 59-48753 (the dyes disclosed therein); EP 0803764A1 (page 19, line 38 to page 20, line 35); JP-A Nos. 2001-272747, 2001-290238, and 2002-023306; etc. These sensitizing dyes may be used singly or in combination. In the present invention, the sensitizing dye is added to the silver halide emulsion preferably during the period of after the desalination step to before the application step, and more preferably during the period of after the desalination step to before the completion of the chemical ripening.

In the present invention, the amount of the sensitizing dye added is preferably 10⁻⁶ mol to 1 mol, and more preferably 10⁻⁴ mol to 10⁻¹ mol, per 1 mol of the silver halide in the image-forming layer, though the amount may be selected depending on the sensitivity and the fogging properties.

A super-sensitizer may be used to increase the spectral sensitization efficiency in the present invention. Examples of the super-sensitizers usable in the present invention include compounds described in EP-A No. 587,338, U.S. Pat. Nos. 3,877,943 and 4,873,184, JP-A Nos. 5-341432, 11-109547, and 10-111543, etc.

10) Combination of Silver Halide In the photothermographic materials of the present invention, one kind of the photosensitive silver halide emulsion may be used, or two or more emulsions with different average grain sizes, different halogen compositions, different crystal habits, different chemical sensitization conditions, etc. may be used in combination. The gradation can be controlled by using a plurality of photosensitive silver halide emulsions having different sensitivities. The techniques therefor are described in JP-A Nos. 57-119341, 53-106125, 47-3929,48-55730, 46-5187, 50-73627, and 57-150841, etc. The sensitivity difference between the emulsions is preferably 0.2 log E or more.

11) Mixing of Silver Halide and Organic Silver Salt

It is particularly preferred that the photosensitive silver halide grains are prepared and chemically sensitized in the absence of the non-photosensitive organic silver salt, though the grains may be prepared by a conversion method as described above.

12) Addition of Silver Halide to Coating Liquid

In the present invention, the silver halide is added to a coating liquid for the image-forming layer preferably during the period of 180 minutes to immediately before the application of the coating liquid, and more preferably during the period of 60 minutes to 10 seconds before the application. There are no particular restrictions in the methods and conditions of the addition, as long as the advantageous effects of the present invention can be sufficiently obtained. Specifically, the silver halide may be mixed with the coating liquid by a method in which the silver halide is mixed in a tank under a condition of a desired average residence time calculated from addition flow rate and feeding amount to a coater, or by a method using a static mixer described in N. Harnby, M. F. Edwards, and A. W. Nienow, translated by Koji Takahashi, Ekitai Kongo Gijutsu, Chapter 8, Nikkan Kogyo Shimbun, Ltd., 1989, etc.

6. Non-Photosensitive Organic Silver Salt

1) Composition

The non-photosensitive organic silver salt used in this invention is relatively stable to light, and forms an image when heated at 80° C. or higher under the presence of the exposed photosensitive silver halide and the reducing agent. The organic silver salt may be any organic substance that can provide a silver ion to be reduced. Such non-photosensitive organic silver salts are described in JP-A No. 10^{-62899,} paragraphs 0048 to 0049; EP 0803764A1, page 18, line 24 to page 19 to line 37; EP 0962812A1; JP-A Nos. 11-349591, 2000-7683, and 2000-72711; etc. The non-photosensitive organic silver salt is preferably a silver salt of an organic acid, particularly a silver salt of a long-chain aliphatic carboxylic acid having a carbon number of 10 to 30, and preferably 15 to 28. Examples of the preferred non-photosensitive organic silver salts include silver behenate, silver arachidate, silver stearate, silver oleate, silver laurate, silver caproate, silver myristate, silver palmitate, and mixtures thereof. In the photothermographic material according to an embodiment of the present invention, the mole ratio of silver behenate to the total of the non-photosensitive organic silver salts is 50% by mole or more. The mole ratio of silver behenate is preferably 50% by mole to 95% by mole, and particularly preferably 60% by mole to 90% by mole. Preferred as the non-photosensitive organic silver salt other than the silver behenate are silver salts of long-chain aliphatic carboxylic acids, and the carbon number of the aliphatic carboxylic acid is preferably 10 to 30, particularly 15 to 28.

2) Shape

The shape of the non-photosensitive organic silver salt is not particularly restricted, and the organic silver salt is preferably in a needle crystal shape having a minor axis and a major axis. It is well known that the size and the covering power of the silver salt crystal grains are in inverse proportion to each other in the field of silver halide photosensitive materials. This is true also in the present invention. The covering power and the image density become lower, as the organic silver salt grains, which forms the image-forming portion of the photothermographic material, are larger. Thus, the size of the organic silver salt grain is preferably reduced. In this invention, it is preferred that the minor axis has a length of 0.01 to 0.15 μm and the major axis has a length of 0.10 to 5.0 μm, and it is more preferred that the minor axis has a length of 0.01 to 0.15 μm and the major axis has a length of 0.10 to 4.0 μm.

The grain size distribution of the organic silver salt grains is preferably a monodisperse distribution. The percentages obtained by dividing the standard deviation of the length of each axis by each length are preferably 100% or less, and more preferably 80% or less, and further preferably 50% or less.

The shape of the organic silver salt can be obtained by observing the organic silver salt dispersion using a transmission electron microscope. The monodisperse distribution may be evaluated by the standard deviation of the volume-weighted average diameter of the organic silver salt, and the percentage (variation coefficient) obtained by dividing the standard deviation by the volume-weighted average diameter is preferably 100% or less, and more preferably 80% or less, and further preferably 50% or less. The grain size of the organic silver salt may be measured by a commercially-available, laser scattering type measuring apparatus.

3) Preparation

The organic silver salt may be prepared by adding an alkaline metal salt (e.g. sodium hydroxide, potassium hydroxide, etc.) to an organic acid, and by mixing the resultant alkaline metal soap of the organic acid with a water-soluble silver salt such as silver nitrate. The silver halide may be mixed therewith in any step. Typical examples of the methods for mixing the silver halide include A) a method in which the silver halide is added to the organic acid beforehand, and then mixed with the water-soluble silver salt after the addition of the alkaline metal salt, B) a method in which the silver halide is mixed with the alkaline metal soap of the organic acid, and then mixed with the water-soluble silver salt, C) a method in which the alkaline metal soap of the organic acid is partly converted to a silver salt, then the silver halide is mixed therewith, and the residue is converted to a silver salt, and D) a method in which the silver halide is added after the preparation of the organic silver salt. The silver halide is mixed preferably by the method of B) or C), and particularly preferably by the method of B).

In the methods of B) and C), it is important that the preliminarily prepared photosensitive silver halide is added in the process of preparing the organic silver salt to prepare a dispersion comprising the silver halide and the organic silver salt. Thus, the photosensitive silver halide is prepared in the absence of the non-photosensitive organic silver salt, and then mixed with the non-photosensitive organic silver salt in the process of preparing the organic silver salt. The silver halide prepared by adding a halogenating agent to the organic silver salt occasionally results in insufficient sensitivity.

In the method of D), the photosensitive silver halide may be mixed with the organic silver salt by a method in which the silver halide and the organic silver salt are separately prepared and then mixed by a high-speed stirrer, a ball mill, a sand mill, a colloid mill, a vibrating mill, a homogenizer, etc., or by a method in which the prepared silver halide is added during the preparation of the organic silver salt and then the organic silver salt is prepared. The effects of the present invention can be preferably obtained by the methods.

The organic silver salt may be prepared by the steps of forming the grains in an aqueous solvent, drying the grains, and redispersing the grains in a solvent such as MEK. The drying step is preferably achieved by an air flow-type flush-jet dryer under a condition of an oxygen partial pressure of 15 vol % or less. The oxygen partial pressure is more preferably 0.01 vol % to 15 vol %, and furthermore preferably 0.01 vol % to 10 vol %.

The amount of the organic silver salt may be selected without particular restrictions, though the coating amount of silver of the organic silver salt and the photosensitive silver halide is preferably 1 g/m² to 1.9 g/m², and more preferably 1 g/m² to 1.7 g/m², and most preferably 1 g/m² to 1.6 g/m².

7. Antifoggant

Examples of antifoggants, stabilizers, and stabilizer precursors usable in the present invention include compounds of patent references described in JP-A No. 10-62899, paragraph 0070 and EP 0803764A1, page 20, line 57 to page 21, line 7; compounds described in JP-A Nos. 9-281637 and 9-329864; and compounds described in U.S. Pat. No. 6,083,681, and EP No. 1048975. Organic halides are preferably used as the antifoggant in the present invention, and examples thereof include ones disclosed in patents described in JP-A No. 11-65021, paragraphs 0111 to 0112. Particularly preferred are organic halogen compounds represented by the formula (P) described in JP-A No. 2000-284399; organic polyhalogen compounds represented by general formula (II) described in JP-A No. 10-339934; and organic polyhalogen compounds described in JP-A Nos. 2001-31644 and 2001-33911.

1) Polyhalogen Compound

The preferred organic polyhalogen compounds usable in the present invention are specifically described below. The preferred polyhalogen compounds are represented by following general formula (H):

Q-(Y)ₙ—C(Z₁)(Z₂)X.

In general formula (H), Q represents an alkyl group, an aryl group, or a heterocyclic group, Y represents a divalent linking group, n represents an integer of 0 or 1, Z₁ and Z₂ represent a halogen atom respectively, and X represents a hydrogen atom or an electron-attractive group.

In general formula (H), Q is preferably an aryl group or a heterocyclic group.

The heterocyclic group represented by Q is preferably a nitrogen-containing heterocyclic group having 1 or 2 nitrogen atoms, and particularly preferably a 2-pyridyl group or a 2-quinolyl group.

The aryl group represented by Q is preferably a phenyl group having a substituent of an electron-attractive group with a positive Hammett's substituent constant σₚ. The Hammett's substituent constant can be obtained with reference to Journal of Medicinal Chemistry, 1973, Vol. 16, No. 11, 1207-1216, etc. Examples of such electron-attractive groups include halogen atoms such as a fluorine atom (σₚ: 0.06), a chlorine atom (σₚ: 0.23), a bromine atom (σₚ: 0.23), and an iodine atom (σₚ: 0.18); trihalomethyl groups such as a tribromomethyl group (σₚ: 0.29), a trichloromethyl group (σₚ: 0.33), and a trifluoromethyl group (σₚ: 0.54); a cyano group (σₚ: 0.66); a nitro group (σₚ: 0.78); aliphatic, aryl, or heterocyclyl sulfonyl groups such as a methanesulfonyl group (σₚ: 0.72); aliphatic, aryl, or heterocyclyl acyl groups such as an acetyl group (σₚ: 0.50) and a benzoyl group (σₚ: 0.43); alkynyl groups such as C≡CH (σₚ: 0.23); aliphatic, aryl, or heterocyclyl oxycarbonyl groups such as a methoxycarbonyl group (σₚ: 0.45) and a phenoxycarbonyl group (σₚ: 0.44); a carbamoyl group (σₚ: 0.36); a sulfamoyl group (σₚ: 0.57); a sulfoxide group; a heterocyclic group; a phosphoryl group; etc. The Hammett's substituent constant σₚ of the electron-attractive group is preferably 0.2 to 2.0, and more preferably 0.4 to 1.0. The electron-attractive group is particularly preferably a carbamoyl group, an alkoxycarbonyl group, an alkylsulfonyl group, or an alkylphosphoryl group, and most preferably a carbamoyl group.

X is preferably an electron-attractive group, and more preferably a halogen atom, an aliphatic, aryl, or heterocyclyl sulfonyl group, an aliphatic, aryl, or heterocyclyl acyl group, an aliphatic, aryl, or heterocyclyl oxycarbonyl group, a carbamoyl group, or a sulfamoyl group, and particularly preferably a halogen atom. The halogen atom of X is preferably a chlorine atom, a bromine atom, or an iodine atom, and more preferably a chlorine atom or a bromine atom, and particularly preferably a bromine atom.

Y is preferably —C(═O)—, —SO—, or —SO₂—, and more preferably —C(═O)— or —SO₂—, and particularly preferably —SO₂—. n is 0 or 1, and preferably 1.

Specific examples of the compounds represented by general formula (H) are illustrated below.

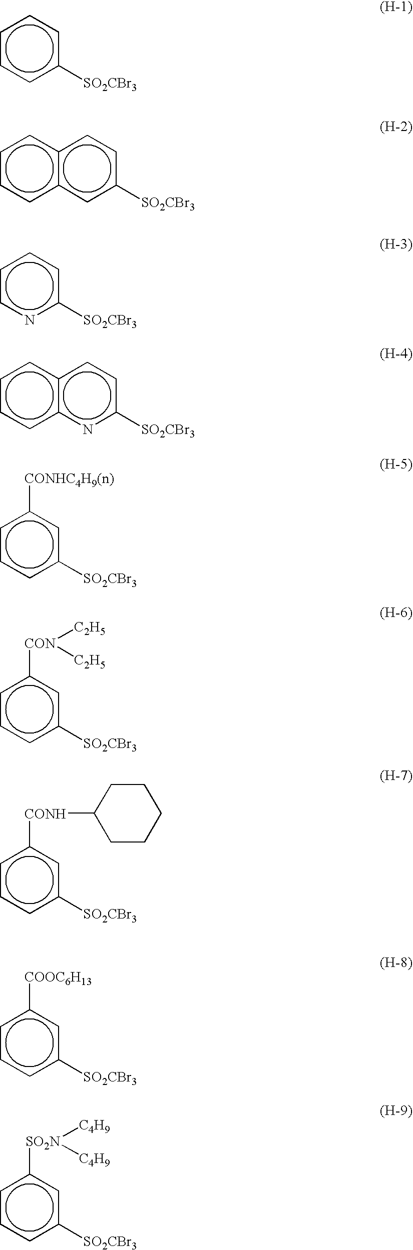

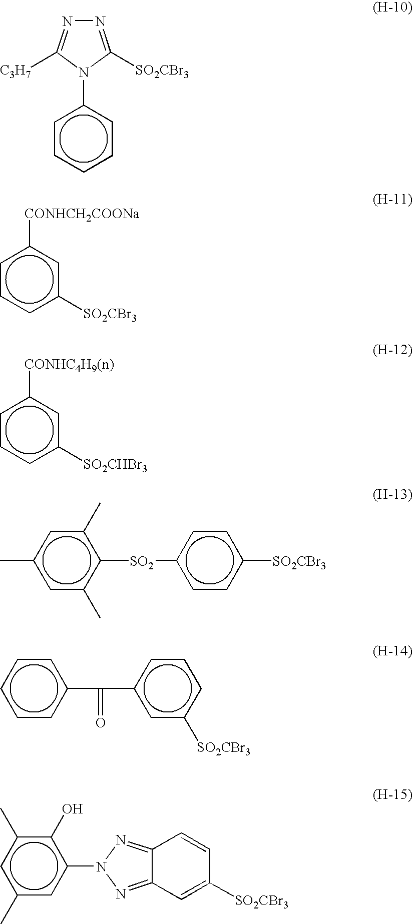

Compounds described in JP-A Nos. 2001-31644, 2001-56526, and 2001-209145 are also preferably used as the polyhalogen compound.

In the present invention, the amount of the compound represented by general formula (H) is preferably 10⁻⁴ mol to 1 mol, and more preferably 10⁻³ mol to 0.5 mol, and further preferably 10⁻² mol to 0.2 mol, per 1 mol of the non-photosensitive silver salt in the image-forming layer.

The antifoggant may be added to the photothermographic material in the same manner as the reducing agent. The organic polyhalogen compound is preferably added as a solution of an organic solvent.

2) Other Antifoggants

Examples of other antifoggants usable in the present invention include mercury (II) salts described in JP-A No. 11-65021, paragraph 0113; benzoic acid compounds described in JP-A No. 11-65021, paragraph 0114; salicylic acid derivatives described in JP-A No. 2000-206642; formalin scavenger compounds represented by the formula (S) described in JP-A No. 2000-221634; triazine compounds according to claim 9 of JP-A No. 11-352624; compounds represented by general formula (III) described in JP-A No. 6-11791; 4-hydroxy-6-methyl-1,3,3a,7-tetrazaindene; etc.

The photothermographic materials of the present invention may contain an azolium salt to prevent the fogging. Examples of the azolium salts include compounds represented by general formula (XI) described in JP-A No. 59-193447; compounds described in JP-B No. 55-12581; and compounds represented by general formula (II) described in JP-A No. 60-153039. The azolium salt is added preferably to a layer in the image-forming layer side of the photothermographic material, and more preferably to the image-forming layer, though it may be added to any portion of the photothermographic material. The azolium salt may be added in any step for preparing the coating liquid. In the case of adding the azolium salt to the image-forming layer, the azolium salt is preferably added during the period of after the preparation of the organic silver salt to immediately before applying the coating liquid, though it may be added in any step between the preparation of the organic silver salt and the preparation of the coating liquid. The azolium salt may be added as powder, solution, fine particle dispersion, etc. Further, the azolium salt may be mixed with another additive such as the sensitizing dye, the reducing agent, and the color toning agent, and added as a solution. The amount of the azolium salt added per 1 mol of silver is preferably 1×10⁻⁶ to 2 mol, and more preferably 1×10⁻³ to 0.5 mol, though it is not restricted.

8. Hydrogen Bonding Compound

In the case where the reducing agent has an aromatic hydroxyl group (—OH) or an amino group, particularly in the case where the reducing agent is the above-mentioned bisphenol reducing agent, a non-reducing compound which has a group capable of forming a hydrogen bond with the hydroxyl or amino group (hereinafter referred to as hydrogen bonding compound) may be used with the reducing agent.

Examples of the groups capable of forming a hydrogen bond with the hydroxyl or amino group include phosphoryl groups, sulfoxide groups, sulfonyl groups, carbonyl groups, amide groups, ester groups, urethane groups, ureido groups, tertiary amino groups, nitrogen-containing aromatic groups, etc. Preferred among the groups are phosphoryl groups; sulfoxide groups; amide groups having no >N—H group, the nitrogen atom thereof being blocked as >N—Ra (in which Ra is a substituent other than H); urethane groups having no >N—H group, the nitrogen atom thereof being blocked as >N—Ra (in which Ra is a substituent other than H); and ureido group having no >N—H group, the nitrogen atom thereof being blocked as >N—Ra (in which Ra is a substituent other than H).

The hydrogen bonding compound used in the present invention is particularly preferably represented by the following general formula (D).

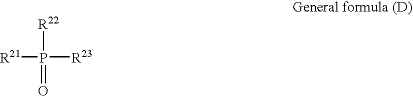

In general formula (D), R²¹ to R²³ each independently represents an alkyl group, an aryl group, an alkoxy group, an aryloxy group, an amino group, or a heterocyclic group. These groups may be unsubstituted or substituted.

Examples of the substituents on the groups of R²¹ to R²³ include halogen atoms, alkyl groups, aryl groups, alkoxy groups, amino groups, acyl groups, acylamino groups, alkylthio groups, arylthio groups, sulfonamide groups, acyloxy groups, oxycarbonyl groups, carbamoyl groups, sulfamoyl groups, sulfonyl groups, phosphoryl groups, etc. Preferred among them are alkyl groups and aryl groups, and examples thereof include a methyl group, an ethyl group, an isopropyl group, a t-butyl group, a t-octyl group, a phenyl group, a 4-alkoxyphenyl group, a 4-acyloxyphenyl group, etc.

Specific examples of the alkyl groups represented by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group.

Specific examples of the aryl groups include a phenyl group, a cresyl group, a xylyl group, a naphtyl group, a 4-t-butylphenyl group, a 4-t-octylphenyl group, a 4-anisidyl group, and a 3,5-dichlorophenyl group.

Specific examples of the alkoxy groups include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, and a benzyloxy group.

Specific examples of the aryloxy groups include a phenoxy group, a cresyloxy group, an isopropylphenoxy group, a 4-t-butylphenoxy group, a naphthoxy group, and a biphenyloxy group.

Specific examples of the amino groups include a dimethylamino group, a diethylamino group, a dibutylamino group, a dioctylamino group, an N-methyl-N-hexylamino group, a dicyclohexylamino group, a diphenylamino group, and an N-methyl-N-phenylamino group.

R²¹ to R²³ are preferably an alkyl group, an aryl group, an alkoxy group, or an aryloxy group, respectively. In view of the effects of the present invention, it is preferred that at least one of R²¹ to R²³ is an alkyl group or an aryl group, and it is more preferred that two or more of R²¹ to R²³ is an alkyl group or an aryl group. Further, it is preferred that R²¹ to R²³ are the same groups from the viewpoint of low cost.

Specific examples of the hydrogen bonding compounds including the compounds represented by general formula (D) are illustrated below without intention of restricting the scope of the present invention.

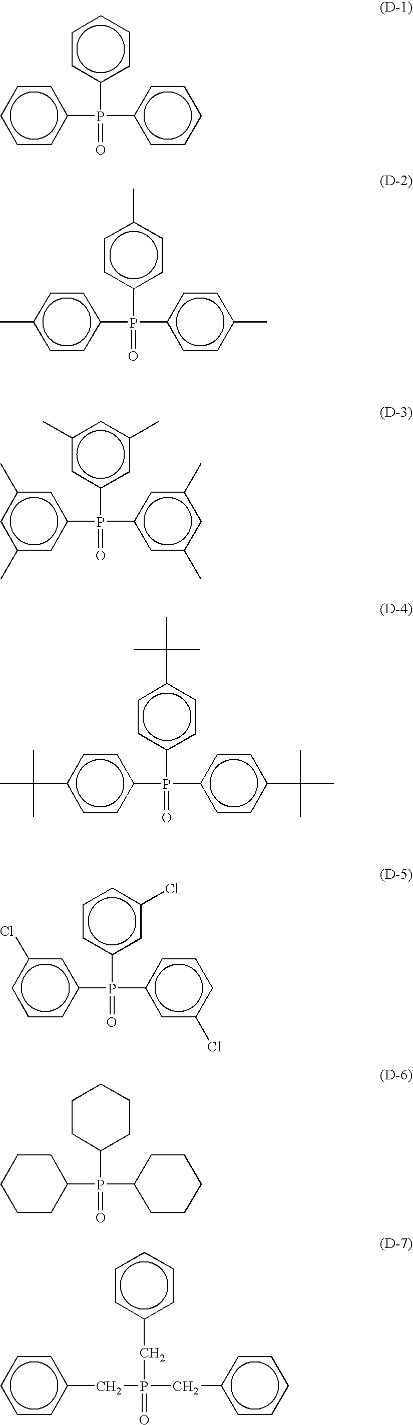

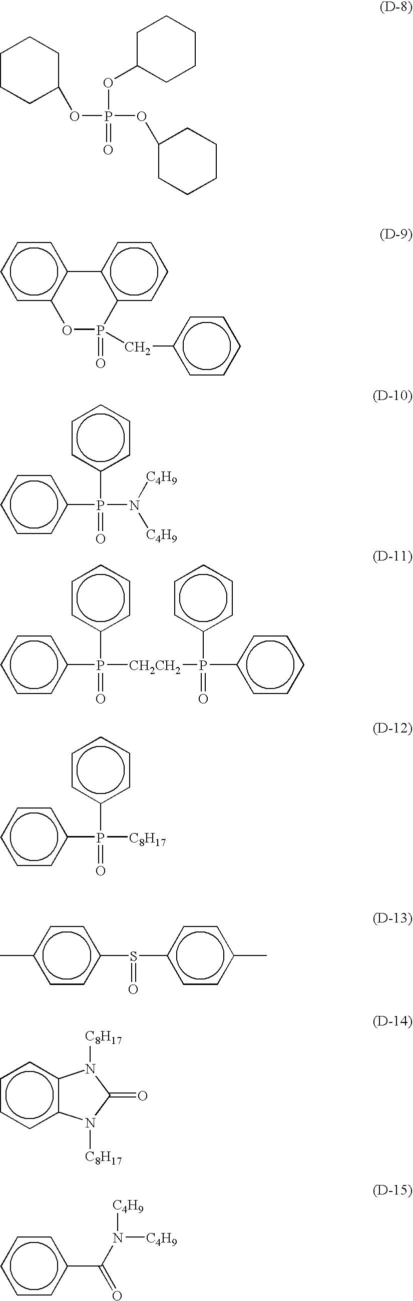

Examples of the hydrogen bonding compounds further include compounds described in EP No. 1096310, and JP-A Nos. 2002-156727 and 2002-318431.

The compound of general formula (D) may be added to the coating liquid and used in the photothermographic material as a solution, an emulsified dispersion, or a solid fine particle dispersion, in the same manner as the reducing agent. The compound is preferably used as a solution. The hydrogen bonding compound forms a hydrogen bonding complex with the reducing agent having a phenolic hydroxyl group or an amino group in the solution. The complex can be isolated as crystal by selecting the combination of the reducing agent and the compound of general formula (D).

The mole ratio of the compound represented by general formula (D) to the reducing agent is preferably 1% by mole to 200% by mole, and more preferably 10% by mole to 150% by mole, and further preferably 20% by mole to 100% by mole.

9. Surface Active Agent

Surface active agents usable in the present invention are described in JP-A No. 11-65021, paragraph 0132.

Fluorine-containing surface active agents are preferably used in the present invention. Specific examples of the fluorine-containing surface active agents include compounds described in JP-A Nos. 10-197985, 2000-19680, and 2000-214554, etc. Further, fluorine-containing polymer surface active agents described in JP-A No. 9-281636 are also preferably used in the present invention. The fluorine-containing surface active agents described in JP-A Nos. 2002-82411 and 2003-057780 are preferably used in the photothermographic materials of the present invention. In the case of using an aqueous coating liquid, the fluorine-containing surface active agents described in JP-A No. 2003-057780 are particularly preferred from the viewpoints of electrification control, stability of the applied surface, and slipping properties.

In the present invention, the fluorine-containing surface active agent may be used in the emulsion layer or the back layer, and preferably in both thereof. The fluorine-containing surface active agent is particularly preferably used in combination with an electrically conducting layer containing a metal oxide. In this case, sufficient performance can be achieved even if the fluorine-containing surface active agent for the electrically conducting layer side is reduced or removed.

The amount of the fluorine-containing surface active agent added to each of the emulsion layer and the back layer is preferably 0.1 mg/m² to 100 mg/m², and more preferably 0.3 mg/m² to 30 mg/m², and further preferably 1 mg/m² to 10 mg/m².

10. Color Toning Agent

It is preferred that a color toning agent is added to the photothermographic materials of the present invention. The color toning agent is described in JP-A No. 10-62899, paragraphs 0054 and 0055, EP 0803764A1, page 21, line 23 to 48, and JP-A No. 2000-356317. Examples of the preferred color toning agents include phthalazinone compounds including phthalazinone, phthalazinone derivatives, and phthalazinone metal salts, such as 4-(1-naphtyl)phthalazinone, 6-chlorophthalazinone, 5,7-dimethoxyphthalazinone, and 2,3-dihydro-1,4-phthalazinone; combinations of phthalazinone compounds and phthalic acid compounds such as phthalic acid, 4-methylphthalic acid, 4-nitrophthalic acid, diammonium phthalate, sodium phthalate, potassium phthalate, and tetrachlorophthalic anhydride; and phthalazine compounds including phthalazine, phthalazine derivatives, and phthalazine metal salts, such as 4-(1-naphtyl)phthalazine, 6-isopropylphthalazine, 6-t-butylphthalazine, 6-chlorophthalazine, 5,7-dimethoxyphthalazine, and 2,3-dihydrophthalazine. Particularly in the case where the color toning agent is combined with the silver halide having a high silver iodide content, the color toning agent preferably comprises a combination of a phthalazine compound and a phthalic acid compound.

11. Other Additives

The photothermographic materials of the present invention may contain a mercapto compound, a disulfide compound, or a thione compound, to control (inhibit or accelerate) the development, to increase the spectral sensitization efficiency, or to increase the storability before and after the development, etc. Such compounds are described in JP-A No. 10-62899, paragraphs 0067 to 0069; JP-A No. 10-186572, paragraphs 0033 to 0052 (the compounds represented by general formula (I) and specific examples thereof; and EP 0803764A1, page 20, lines 36 to 56. The mercapto-substituted, aromatic, heterocyclic compounds described in JP-A Nos. 9-297367, 9-304875, 2001-100358, 2002-303954, and 2002-303951, etc. are preferably used in the present invention.

Plasticizers and lubricants usable for the image-forming layer according to the present invention are described in JP-A No. 11-65021, paragraph 0117. Slipping agents usable in the present invention are described in JP-A No. 11-84573, paragraphs 0061 to 0064.

Various kinds of dyes and pigments such as C.I. Pigment Blue 60, C.I. Pigment Blue 64, and C.I. Pigment Blue 15:6 may be used in the image-forming layer, in view of improving the color tone, preventing generation of interference fringe due to laser exposure, and preventing irradiation. They are described in detail in WO 98/36322, JP-A Nos. 10-268465 and 11-338098, etc.

It is preferred that a super hard toner is added to the image-forming layer to form a super hard image suitable for printing. The super hard toners, methods for adding them, and amount thereof are described in JP-A No. 11-65021, paragraph 0118; JP-A No. 11-223898, paragraphs 0136 to 0193; and JP-A No. 2000-284399 (the compounds represented by any one of the formulae (H), (1) to (3), (A), and (B). Hard gradation enhancing agents are described in JP-A No. 11-65021, paragraph 0102, and JP-A No. 11-223898, paragraphs 0194 and 0195.

In the case of using formic acid or a formate salt as a strong fogging agent, it is preferably contained on the side of the image-forming layer containing the photosensitive silver halide, and the amount thereof is preferably 5 mmol or less, and more preferably 1 mmol or less, per 1 mol of silver.

In the present invention, the super hard toner is preferably used with an acid generated by hydration of diphosphorus pentaoxide or a salt thereof. Examples of the acids generated by hydration of diphosphorus pentaoxide and the salts thereof include metaphosphoric acid, pyrophosphoric acid, orthophosphoric acid, triphosphoric acid, tetraphosphoric acid, hexametaphosphoric acid, and salts thereof. Particularly preferred as the acid generated by hydration of diphosphorus pentaoxide or the salt thereof are orthophosphoric acid, hexametaphosphoric acid, and salts thereof. Specific examples of the salts include sodium orthophosphate, sodium dihydrogen orthophosphate, sodium hexametaphosphate, and ammonium hexametaphosphate.

The coating amount of the acid generated by hydration of diphosphorus pentaoxide or the salt thereof per 1 m² of the photothermographic material is preferably 0.1 mg/m² to 500 mg/m², and more preferably 0.5 mg/m² to 100 mg/m², though it may be selected depending on the sensitivity, the fogging properties, etc.

12. Description of Layer Structure and Other Components

The photothermographic materials of the present invention may comprise non-photosensitive layers in addition to the image-forming layer. These non-photosensitive layers may be classified depending on the position into (a) surface protective layers disposed on the image-forming layer (on the opposite side of the support side), (b) intermediate layers disposed between a plurality of the image-forming layers or between the image-forming layer and the protective layer, (c) undercoat layers disposed between the image-forming layer and the support, and (d) back layers disposed on the opposite side of the image-forming layer side.

Further, a filter layer, which acts as an optical filter, may be formed as the layer of (a) or (b) in the photothermographic materials. The antihalation layer may be formed as the layer of (c) or (d) in the photothermographic materials.

1) Surface Protective Layer

The photothermographic materials of the present invention may comprise a surface protective layer to prevent the adhesion of the image-forming layer, etc. The surface protective layer may have a single-or multi-layer structure. Such a surface protective layer is described in JP-A No. 11-65021, paragraphs 0119 and 0120, and JP-A No. 2001-348546.

A binder for the surface protective layer may be any polymer such as a polyester, a gelatin, a polyvinyl alcohol, and a cellulose derivative. The binder is preferably a cellulose derivative. Examples of the cellulose derivatives include cellulose acetate, cellulose acetate butyrate, cellulose propionate, hydroxypropyl cellulose, hydroxypropylmethyl cellulose, methyl cellulose, hydroxyethyl cellulose, carboxymethyl cellulose, and mixtures thereof, and the present invention is not restricted to the examples. The thickness of the surface protective layer is preferably 0.1 μm to 10 μm, and particularly preferably 1 μm to 5 μm.

The surface protective layer may contain an adhesion-preventing material. Examples of the adhesion-preventing materials include waxes, liquid paraffins, silica particles, styrene-containing elastomeric block copolymers (e.g. styrene-butadiene-styrene copolymers, styrene-isoprene-styrene copolymers, etc.), cellulose acetates, cellulose acetate butyrates, cellulose propionates, and mixtures thereof.

2) Antihalation Layer

In the photothermographic materials of the present invention, the antihalation layer may be disposed farther from the exposure light source than the image-forming layer. Such antihalation layers are described in JP-A No. 11-65021, paragraphs 0123 and 0124, and JP-A Nos. 11-223898, 9-230531, 10-36695, 10-104779, 11-231457, 11-352625, and 11-352626, etc.

The antihalation layer may contain an antihalation dye having absorption in the exposure wavelength range. In the case where the exposure wavelength is within the infrared range, an infrared-absorbing dye may be used as the antihalation dye. The infrared-absorbing dye preferably has no absorption in the visible light range.

In the case of using a dye having absorption in the visible light range to prevent the halation, it is preferred that the color of the dye does not substantially remain after the image formation. The color of the dye is preferably faded by heat during the heat development. In particular, it is preferred that a heat color fading dye and a base precursor are added to the non-photosensitive layer to form the antihalation layer. These techniques are described in JP-A No. 11-231457, etc.

The amount of the color fading dye may be determined depending on the purpose. The color fading dye is generally used such that the optical density (the absorbancy) at a desired wavelength exceeds 0.1. The optical density is preferably 0.2 to 2. To obtain such an optical density, the amount of the color fading dye is generally 0.001 g/m² to 1 g/m².

In the case where the dye is thus faded, the optical density can be lowered to 0.1 or less after the heat development. Two or more color fading dyes may be used in combination in a heat fading type recording material or photothermographic material. Two or more base precursors may be used in combination similarly.

In the heat color fading, it is preferred that a substance, such that the melting point thereof is lowered by 3° C. or more when mixed with the base precursor, is used with the color fading dye and the base precursor in view of the heat color fading properties as described in JP-A No. 11-352626. Examples of the substance include diphenylsulfone, 4-chlorophenyl(phenyl)sulfone, etc.

3) Back Layer

The back layers usable in the present invention are described in JP-A No. 11-65021, paragraphs 0128 to 0130.

The back layer may contain a binder, which is transparent or translucent, and generally colorless. The binder may be a natural polymer, a synthetic resin, polymer or copolymer, or another film-forming medium, and specific examples thereof include gelatins, arabic gums, polyvinyl alcohols, hydroxyethyl celluloses, cellulose acetates, cellulose acetate butyrates, polyvinylpyrrolidones, caseins, starches, polyacrylic acids, polymethylmethacrylic acids, polyvinyl chlorides, polymethacrylic acids, styrene-maleic anhydride copolymers, styrene-acrylonitrile copolymers, styrene-butadiene copolymers, polyvinyl acetals (e.g. polyvinyl formals, polyvinyl butyrals, etc.), polyesters, polyurethanes, phenoxy resins, polyvinylidene chlorides, polyepoxides, polycarbonates, polyvinyl acetates, cellulose esters, and polyamides. The binder may be formed into a coating from an aqueous solution, an organic solvent, or an emulsion.

In the present invention, a coloring agent having absorption maximum within the range of 300 to 450 nm may be added to the photothermographic material to improve the color tone of silver and the image deterioration with time. Such coloring agents are described in JP-A Nos. 62-210458, 63-104046, 63-103235, 63-208846, 63-306436, 63-314535, 01-61745, 2001-100363, etc. The amount of the coloring agent added is generally 0.1 mg/m² to 1 g/m². The coloring agent is preferably added to the back layer disposed on the opposite side of the image-forming layer side.

4) Antistatic Layer

The photothermographic materials of the present invention may comprise an antistatic layer containing a known metal oxide or electrically conductive polymer, etc. The antistatic layer may act also as the undercoat layer, the back layer, the surface protective layer, etc., and may be formed separately therefrom. Technologies described in JP-A No.11-65021, paragraph 0135, JP-A Nos. 56-143430, 56-143431, 58-62646, and 56-120519, JP-A No. 11-84573, paragraphs 0040 to 0051, U.S. Pat. No. 5,575,957, and JP-A No. 11-223898, paragraphs 0078 to 0084 may be used for the antistatic layer in the present invention.

5) Additives

5-1) Matting Agent

In the present invention, a matting agent is preferably added to the surface protective layer and the back layer to improve the conveyability. The matting agent is described in JP-A No. 11-65021, paragraphs 0126 and 0127.

The coating amount of the matting agent per 1 m² of the photothermographic material is preferably 1 mg/m² to 400 mg/m², and more preferably 5 mg/m² to 300 mg/m².

The mattness of the emulsion surface is not limited as long as so-called star defects, in which small white spots are formed in the image-forming portion with light leak, are not caused. The Beck smoothness of the surface is preferably 200 to 10,000 seconds, and particularly preferably 300 to 8,000 seconds. The Beck smoothness can be easily obtained by “Method for testing smoothness of paper and paperboard by Beck tester” according to JIS P8119, or TAPPI standard method T479.

The mattness of the back layer is preferably such that the Beck smoothness is 10 to 250 seconds. The Beck smoothness is more preferably 50 to 180 seconds.

In the present invention, the matting agent is preferably contained in the outermost layer, a layer acting as the outermost layer, a layer near the outer surface, or the protective layer of the photothermographic material.

Organic or inorganic fine particles insoluble in the coating solvent may be used as the matting agent in the present invention. The matting agent may be such as well known in the field, and examples thereof include organic matting agents described in U.S. Pat. Nos. 1,939,213, 2,701,245, 2,322,037, 3,262,782, 3,539,344, and 3,767,448, etc.; and inorganic matting agents described in U.S. Pat. Nos. 1,260,772, 2,192,241, 3,257,206, 3,370,951, 3,523,022, and 3,769,020, etc. Specific examples of the preferred organic matting agents include water dispersible vinyl polymers such as polymethyl acrylates, polymethyl methacrylates, polyacrylonitriles, acrylonitrile-α-methylstyrene copolymers, polystyrenes, styrene-divinylbenzene copolymers, polyvinyl acetates, polyethylene carbonates, and polytetrafluoroethylenes; cellulose derivatives such as methyl celluloses, cellulose acetates, and cellulose acetate propionates; starch derivatives such as carboxy starches, carboxynitrophenyl starches, and urea-formaldehyde-starch reaction products; gelatins hardened by a known curing agent; and hardened gelatins prepared by coacervate hardening as fine hollow capsule particles. Specific examples of the preferred inorganic matting agents include silicon dioxide, titanium dioxide, magnesium dioxide, aluminium oxide, barium sulfate, calcium carbonate, silver chlorides and silver bromides desensitized by a known method, glasses, diatomaceous earth, etc. The matting agents may be used as a mixture of different compounds. There are no particular restrictions in the size and shape of the particles of the matting agent, the particle diameter may be optionally selected. In the present invention, the particle diameter of the matting agent particles is preferably 0.1 μm to 30 μm. The particle size distribution of the matting agent may be narrow or wide. Because the matting agent remarkably affects the haze and the surface glossiness of the photothermographic material, the particle diameter, shape, and particle size distribution of the matting agent are preferably controlled by changing the conditions of preparing the matting agent or mixing a plurality of the matting agents if necessary.

5-2) Film Hardener

A film hardener may be used in the image-forming layer, the protective layer, the back layer, etc.

Examples of the film hardeners are described in T. H. James, The Theory of the Photographic Process, Fourth Edition, pages 77 to 87, Macmillan Publishing Co., Inc., 1977, etc. Specific examples of the preferred film hardeners include chromium alum; 2,4-dichloro-6-hydroxy-s-triazine sodium salt; N,N-ethylenebis(vinylsulfonacetamide); N,N-propylenebis (vinylsulfonacetamide); polyvalent metal ions described in page 78 of the above reference; polyisocyanates described in U.S. Pat. No. 4,281,060, JP-A No. 6-208193, etc.; epoxy compounds described in U.S. Pat. No. 4,791,042, etc.; and vinylsulfone compounds described in JP-A No. 62-89048, etc. In particular, the film hardener is preferably a vinylsulfone compound, and more preferably a diffusion resistant vinylsulfone compound.

The film hardener is added as a solution. The solution is added to a coating liquid for the protective layer during the period of from 180 minutes before to immediately before the application of the coating liquid, preferably during the period of from 60 minutes before to 10 seconds before the application, though the method and conditions of adding the film hardener are not particularly limited as long as the advantageous effects of the present invention can be sufficiently obtained.

Specifically, the film hardener may be added to the coating liquid by a method in which the film hardener is added in a tank under a condition of a desired average residence time calculated from addition flow rate and feeding amount to a coater, or by a method using a static mixer described in N. Harnby, M. F. Edwards, and A. W. Nienow, translated by Koji Takahashi, Ekitai Kongo Gijutsu, Chapter 8, Nikkan Kogyo Shimbun, Ltd., 1989, etc.

5-3) Surface Active Agent

A surface active agent may be used for the photothermographic materials of the present invention to improve the coating property, the static charge, etc. The surface active agent may be a nonionic, anionic, cationic, or fluorine-containing agent. Examples of the surface active agents include fluorine-containing polymer surface active agents described in JP-A No. 62-170950, U.S. Pat. No. 5,380,644, etc.; fluorine-containing surface active agents described in JP-A Nos. 60-244945 and 63-188135, etc.; polysiloxane-based surface active agents described in U.S. Pat. No. 3,885,965, etc.; and polyalkylene oxides and anionic surface active agents described in JP-A No. 6-301140, etc.

In the present invention, the fluorine-containing surface active agents are particularly preferably used. Specific examples of the preferred fluorine-containing surface active agents include compounds described in JP-A Nos. 10-197985, 2000-19680, and 2000-214554, etc. Further, the high molecular fluorine-containing surface active agents described in JP-A No. 9-281636 are also preferably used in the present invention.

5-4) Other Additives

An antioxidant, a stabilizing agent, a plasticizer, a UV absorbent, or a coating aid may be added to each layer of the photothermographic material. The solvent described in JP-A No. 11-65021, paragraph 0133 may be added to the photothermographic material. The additives may be added to the image-forming layer or the non-photosensitive layer. The additives may be added with reference to WO 98/36322, EP 803764A1, JP-A Nos. 10-186567 and 10-18568, etc.

6) Surface pH

The photothermographic materials of the present invention preferably show a surface pH of 7.0 or less before the heat development. The surface pH is more preferably 6.6 or less. The lower limit of the surface pH is approximately 3, though it is not particularly restricted. The surface pH is most preferably 4 to 6.2.

It is preferred that the surface pH is controlled by using an organic acid such as a phthalic acid derivative, a nonvolatile acid such as sulfuric acid, or a volatile base such as ammonia, from the viewpoint of reducing the surface pH. Ammonia is particularly preferably used to obtain the low surface pH, because ammonia can be easily volatilized and removed in the application step or before the heat development.

Further, it is also preferred that ammonia is used in combination with a nonvolatile base such as sodium hydroxide, potassium hydroxide, and lithium hydroxide. A method for measuring the surface pH is described in JP-A No. 2000-284399, paragraph 0123.

7) Support

The support may be a polyester film, a undercoated polyester film, a polyethylene terephthalate film, a polyethylene naphthalate film, a cellulose nitrate film, a cellulose ester film, a polyvinyl acetal film, a polycarbonate film, a film of a derivative thereof, a film of a resin, a glass, paper, a metal, etc. Further, the support may be a flexible support, particularly a partially acetylated paper support or a paper support coated with baryta and/or an α-olefin polymer, particularly an α-olefin polymer having a carbon number of 2 to 10 such as polyethylene, polypropylene, and an ethylene-butene copolymer. The support is preferably transparent, though it may be opaque.

A polyester, particularly a polyethylene terephthalate, which is subjected to a heat treatment at 130 to 185° C. to relax internal strains remaining in the film during biaxial stretching and to eliminate heat shrinkage strains generated during the heat development, is preferably used for the support.

In the case where the photothermographic material is for medical use, the transparent support may be colored by a blue dye (e.g., Dye-1 described in Examples of JP-A No. 8-240877) or uncolored. Specific examples of the supports are described in JP-A No. 11-65021, paragraph 0134.

The support preferably comprises an undercoating of a water-soluble polyester described in JP-A No. 11-84574, a styrene butadiene copolymer described in JP-A No. 10-186565, a vinylidene chloride copolymer described in JP-A No. 2000-39684, etc.

8) Coating Method

The photothermographic materials of the present invention may be formed by any coating method. Specifically, the coating method may be extrusion coating, slide coating, curtain coating, dip coating, knife coating, flow coating, extrusion coating using a hopper described in U.S. Pat. No. 2,681,294, etc. The coating method is preferably extrusion coating described in Stephen F. Kistler and Petert M. Schweizer, Liquid Film Coating, CHAPMAN & HALL, 1997, pages 399 to 536, or slide coating. Particularly preferred coating method is extrusion coating.

9) Packaging Material

The photothermographic materials of the present invention are preferably sealed by a packaging material having a low oxygen transmittance and/or a low water transmittance, to prevent deterioration of the photographic properties during the storage, or to provide the materials as a roll without curling. The oxygen transmittance is preferably 50 ml/atm/m²·day or less, and more preferably 10 ml/atm/m² ·day or less, and furthermore preferably 1.0 ml/atm/m²·day or less, at 25° C. The water transmittance is preferably 10 g/atm/m²·day or less, and more preferably 5 g/atm/m²·day or less, and furthermore preferably 1 g/atm/m²·day or less. Specific examples of the packaging materials having a low oxygen transmittance and/or a low water transmittance include ones described in JP-A Nos. 8-254793 and 2000-206653.

10) Other Usable Technologies

Technologies described in EP 803764A1, EP 883022A1, WO 98/36322, and JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, and 2001-348546 are usable for the photothermographic materials of the present invention.

11) Formation of Color Image

In the case of using the photothermographic material of the present invention as a multicolor photothermographic material, it may comprise a combination of two layers for each color or comprise a single layer containing all the components as described in U.S. Pat. No. 4,708,928.

In the multicolor photothermographic material, the emulsion layers are generally separated by using a functional or non-functional barrier layer between the photosensitive layers as described in U.S. Pat. No. 4,460,681.

13. Image Forming Methods

1) Exposure

The photothermographic materials of the present invention are preferably exposed by an exposure light source using a laser light, though there are no restrictions in the exposure method. The light intensity on the surface of the photothermographic material is preferably 0. 1 W/mm² to 100 W/mm², and more preferably 0.5 W/mm² to 50 W/mm², and most preferably 1 W/mm² to 50 W/mm².

The laser light may be gas laser (Ar⁺, He—Ne, He—Cd, etc.), YAG laser, dye laser, semiconductor laser, etc. Further, a semiconductor laser light may be used with a second higher harmonics generating device. Preferred lasers are infrared emission He—Ne laser and infrared semiconductor laser, though they may be selected depending on the light absorption peak wavelength of the spectrally sensitizing dye, etc. in the photothermographic material. Among the lasers, infrared semiconductor lasers can stably emit a light with reduced costs to be particularly suitable for designing a laser image output system, which is compact and excellent in operationality and can be used in any installation location with ease.

It is also preferred that the laser light is emitted in vertical multimode by high frequency superposition, etc.

2) Heat Development

The photothermographic materials of the present invention are generally exposed imagewise and then heat-developed, and there are no restrictions in the heat development method. The development temperature is preferably 80° C. to 250° C., more preferably 100° C. to 140° C., and further preferably 110° C. to 130° C. The development time is preferably 1 second to 60 seconds, and more preferably 1 second to 30 seconds, and furthermore preferably 1 second to 14 seconds, and particularly preferably 3 seconds to 13 seconds.

A heater used for the heat development may be a drum heater or a plate heater, preferably a plate heater. A heat development method using a heat development apparatus with a plate heater described in JP-A No. 11-133572 is preferably used in the present invention. The heat development apparatus comprises a heat developing portion, and a visible image is formed by the apparatus by the steps of forming a latent image on a photothermographic material, and bringing the photothermographic material into contact with a heating unit in the heat developing portion. In the heat development apparatus, the heating unit comprises the plate heater, a plurality of press rollers facing each other are arranged along one surface of the plate heater, and the photothermographic material is passed between the rollers and the plate heater and thus heat-developed. It is preferred that the plate heater is divided into two to six stages and the temperature of the tip portion thereof is lowered by approximately 1° C. to 10° C. For example, 4 plate heaters may be independently controlled into 112° C., 119° C., 121° C., and 120° C. Such a method is described also in JP-A No. 54-30032. In the method, moisture and an organic solvent contained in the photothermographic material can be removed, and deformation of the support due to rapid heating can be prevented.

The photothermographic materials of the present invention may be developed by a heat development method in which the image-forming layer side is heated by a heat drum. When conventional photothermographic materials are developed by this heat development method, defective feeding is often caused. However, in the case of the photothermographic materials of the present invention, such defective feeding is extremely rarely caused.

The heat development method is advantageous in that the photothermographic material is not rubbed with the heat drum in the developing step, whereby the photothermographic material and the heat drum are hardly scratched. Thus, the photothermographic materials of the present invention hardly strain the heat developing apparatus.

14. System

Fuji Medical Dry Laser Imager FM-DP L is known as a laser imager for medical use comprising an exposure portion and a heat developing portion. FM-DP L is described in Fuji Medical Review, No. 8, pages 39 to 55, and the technologies thereof can be applied to the present invention needless to note. The photothermographic materials of the present invention can be used for the laser imager in AD Network proposed by Fuji Medical System as a network system according to DICOM Standards.

The time between power-off of the laser imager and output of the first image is preferably 15 minutes or less.

When the photothermographic material and the heat developing apparatus are combined to output an image, the maximum density of the image is preferably 3.3 or more. The maximum density depends on, for example, the sensitivity of the photothermographic material and the laser output of the laser imager. The maximum density of 3.3 or more is more easily obtained, as the sensitivity of the photothermographic material is higher, or as the output of the laser imager is higher. The sensitivity of the photothermographic material can be increased by using the reducing agent or the development accelerator according to the present invention, and any method may be used in the present invention to increase the sensitivity.

15. Use of Photothermographic Materials

It is preferred that the photothermographic materials of the present invention form a black and white image of silver and are used for medical diagnoses, industrial photographs, printings, or COM.

### EXAMPLES

The present invention will be described below with reference to Examples without intention of restricting the scope of the present invention.

### Example 1

1. Preparation of PET Support and Undercoating

1-1. Film Formation

A PET having an intrinsic viscosity IV of 0.66, which was measured in a mixture of phenol/tetrachloroethane=6/4 (weight ratio) at 25° C., was prepared from terephthalic acid and ethylene glycol by a common procedure. The PET was converted into a pellet, dried at 130° C. for 4 hours, and melted at 300° C., and 0.04% by mass of Dye BB of the following formula was added thereto. The resulting mixture was extruded from a T-die and rapidly cooled to prepare an unstretched film a thickness to be changed into 175 μm by thermal fixation.

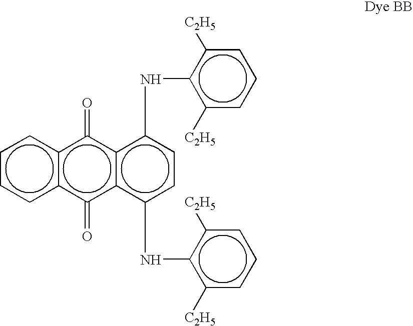

The unstretched film was stretched 3.3 times in the longitudinal direction at 110° C. by rollers with different peripheral speeds, and then stretched 4.5 times in the horizontal direction at 130° C. by a tenter. The film was subjected to thermal fixation at 240° C. for 20 seconds, and relaxed by 4% in the horizontal direction at the temperature. Then, the chuck of the tenter was slit, the both ends of the film were knurled, and the film was rolled up into 4 kg/cm², to obtain a roll having a thickness of 175 μm.

1-2. Surface Corona Discharge Treatment

Both surfaces of the support were treated at the room temperature at 20 m/minute using a solid state corona discharge treatment machine Model 6KVA manufactured by Piller Inc. The electric current and voltage were read during the treatment, whereby it was found that the support was subjected to the treatment of 0.375 kV·A·minute/m². The discharging frequency of the treatment was 9.6 kHz, and the gap clearance between the electrode and the dielectric roll was 1.6 mm.

2. Preparation and Application of Coating Liquid for Back Layer

84.2 g of cellulose acetate butyrate CAB381-20 available from Eastman Chemical Co. and 4.5 g of a polyester resin Vitel PE2200B available from Bostic Co. were added to and dissolved in 830 g of MEK while stirring. 0.30 g of Dye 1 was added to the resulting solution, and thereto was added a solution prepared by dissolving 4.5 g of fluorine-containing active agent SURFLON KH40 available from Asahi Glass Co. Ltd. and 2.3 g of fluorine-containing active agent MEGAFAG F120K available from Dainippon Ink and Chemicals, Inc. in 43.2 g of methanol. The resultant was sufficiently stirred until the active agents were dissolved. Then, 75 g of silica SILOID 64×6000 available from W. R. Grace Co., which was dispersed in methyl ethyl ketone into a concentration of 1% by mass by a dissolver type homogenizer, was further added thereto and stirred to obtain a coating liquid for back layer.

Thus-prepared coating liquid for back layer was applied onto the support by an extrusion coater and dried at 100° C. by air flow with a dew point of 10° C. over 5 minute, to form a dry layer having the dry thickness of 3.5 μm.

3. Image-Forming Layer and Surface Protective Layer

3-1. Preparation of Materials to be Applied

1) Silver Halide Emulsion

(Preparation of Silver Halide Emulsion 1)

30 g of phthalated gelatin and 71.4 mg of KBr were dissolved in 1500 ml of deionized water, and pH of the resultant solution was adjusted to 5.0 by a 3 mol/L aqueous nitric acid, to obtain a first solution. A liquid prepared by dissolving 27.4 g of KBr and 3.3 g of KI in 275 ml of deionized water, and a liquid prepared by dissolving 42.5 g of silver nitrate in 364 ml of deionized water were simultaneously added to the first solution over 9.5 minutes while keeping the solution at 34° C. Then, a liquid prepared by dissolving 179 g of KBr and 10 mg of dipotassium hexachloroiridate in 812 ml of deionized water, and a liquid prepared by dissolving 127 g of silver nitrate in 1090 ml of deionized water were mixed therewith over 28.5 minutes. The pAg of the solution was kept uniform by a pAg feedback control loop described in Research Disclosure, No. 17643, and U.S. Pat. Nos. 3,415,650, 3,782,954, and 3,821,002. Thus-obtained emulsion was desalted by water-washing. The average particle size of the emulsion was measured by a transmission electron microscope (TEM), and as a result, the average particle size was 0.045 μm.

Thus-prepared core-shell type silver iodobromide emulsion had the core with the iodo content of 8% by mole, the shell with the iodo content of 0% by mole, and the total iodo content of 2% by mole, and contained iridium of 2.1×10⁻⁵ mol per 1 mol of the silver halide.

2) Preparation of Silver Halide/Organic Silver Salt Dispersion

688 g of a fatty acid composition comprising 55% by mole of behenic acid, 28% by mole of arachidic acid, and 17% by mole of stearic acid was dissolved in 13 L of water at 80° C., and stirred for 15 minutes. To the resultant was added a liquid prepared by dissolving 89.18 g of NaOH in 1.5 L of water at 80° C., and stirred for 5 minutes, to prepare a dispersion. A liquid prepared by diluting 19 ml of a concentrated nitric acid solution with 50 ml of water was added to the dispersion at 80° C. Then, the dispersion was cooled to 55° C. and stirred for 25 minutes, and a diluted emulsion was added to the dispersion at 55° C. and mixed for 5 minutes. The diluted emulsion was prepared by dissolving 700 g of the above-obtained iridium-doped silver halide emulsion containing 1 mol of the silver halide in 1.25 L of water at 42° C., and added in an amount corresponding to 0.10 mol of the silver halide. Further, 336.5 g of silver nitrate was dissolved in 2.5 L of water, and the resulting solution was added to the above dispersion at 55° C. over 10 minutes. Then, thus-obtained organic silver salt dispersion was transferred into a water-washing vessel, deionized water was added thereto, and the resulting dispersion was stirred and left, whereby the organic silver salt dispersion was raised and separated from water-soluble salts precipitated. The organic silver salt dispersion was subjected to repetition of washing with deionized water and filtration until the conductivity of the filtrate became 2 μS/cm. The dispersion was then subjected to centrifugal dewatering, and dried at 45° C. by a circulating dryer using a warm air with oxygen partial pressure of 10% until the weight became uniform.

3) Redispersion of Organic Silver Salts Including Photosensitive Silver Halide in Organic Solvent

209 g of the above organic silver salt powder and 11 g of polyvinyl butyral powder BUTVAR B-79 available from Monsanto Company were dissolved in 780 g of methyl ethyl ketone (MEK), stirred by a dissolver DISPERMAT CA-40M available from VMA-GETZMANN, and left at 7° C. overnight, to obtain a slurry.

The slurry was two-pass-dispersed by a pressure homogenizer GM-2 available from S. M. T. Co. to prepare a dispersion of organic silver salts including the photosensitive emulsion. The treatment pressure at the first pass was 6000 psi.

4) Preparation of Coating Liquid for Image-Forming Layer

<<Preparation of Coating Liquid 1 for Image-Forming Layer>>

15.1 g of MEK was added to 50 g of the above organic silver salt dispersion, and stirred at 2 1° C. by a dissolver type homogenizer at 1000 rpm. 390 μl of a 10% by mass methanol solution of an association of N,N-dimethylacetamide (2 molecules)/oxalic acid (1 molecule)/bromine (1 molecule) was added to the resultant mixture and stirred for 30 minutes. Further, 494 μl of a 10% by mass methanol solution of calcium bromide was added thereto and stirred for 20 minutes.

Then, 167 mg of a methanol solution containing 15.9% by mass of dibenzo-18-crown-6 and 4.9% by mass of potassium acetate was added to the resultant mixture and stirred for 10 minutes. 18.3% by mass of 2-chloro benzoic acid, 34.2% by mass of salicylic acid p-toluenesulfonate, and 2.6 g of Sensitizing dye 1 (0.24% by mass MEK solution) was added thereto and stirred for 1 hour. The temperature of the mixture was lowered to 13° C., and the mixture was further stirred for 30 minutes. 13.31 g of polyvinyl butyral BUTVAR B-79 available from Monsanto Company was added thereto and stirred for 30 minutes, and 1.08 g of a 9.4% by mass tetrachloro phthalic acid solution was added thereto and stirred for 15 minutes, while maintaining the temperature at 13° C. Then, the Reducing agent 1 was added to the mixture in an amount of 0.4 mol per 1 mol of silver while stirring.

1.1% by mass of 4-methylphthalic acid and 12.4 g of a MEK solution of Dye 1 were added to the mixture, and then 1.5 g of a 10% by mass solution of aliphatic isocyanate DESMODUR N3300 available from Movey Co. was added thereto. Further, 13.7 g of a 7.4% by mass MEK solution of Polyhalogen compound 1, and 4.27 g of a 7.2% by mass MEK solution of phthalazine were added to the resulting mixture to obtain Coating liquid 1 for an image-forming layer.

<<Preparation of Coating Liquids 2 to 14 for Image-Forming Layer>>

Coating liquids 2 to 14 for image-forming layer were prepared in the same manner as Coating liquid 1 except that each binder shown in Table 1 was used instead of the polyvinyl butyral BUTVAR B-79 available from Monsanto Company, and each reducing agent shown in Table 1 was used instead of Reducing agent 1, respectively.

It should be noted that the dispersion binder used in the organic silver salt dispersion was the same as the above binder in each of the Coating liquids 2 to 14.

5) Preparation of Coating Liquid for Surface Protective Layer

96 g of cellulose acetate butyrate CAB 171-15 available from gEastman Chemical Co., 4.5 g of polymethylmethacrylic acid PARALOID A-21 available from Rohm & Haas Co., 1.5 g of 1,3-di(vinylsulfonyl)-2-propanol, 1.0 g of benzotriazole, and 1.0 g of fluorine-containing active agent SURFLON KH40 available from Asahi Glass Co. Ltd. were added to and dissolved in 865 g of MEK while stirring. Then, 13.6% by mass of cellulose acetate butyrate CAB 171-15 available from Eastman Chemical Co. and 9% by mass of calcium carbonate Super—Pflex200 available from Speciality Minerals Co. were dispersed in MEK by a dissolver type homogenizer at 8000 rpm for 30 minutes, and 30 g of the resultant dispersion was added to the above MEK solution to prepare a coating liquid for surface protective layer.

3-2. Production of Photothermographic Material

Photothermographic materials 1 to 14 were produced such that each of Coating liquid 1 to 14 for image-forming layer and the coating liquid for surface protective layer, prepared as above, were simultaneously multi-layer-coated by a dual knife coater on the opposite side of the back layer side, respectively. The coating of the coating liquids was carried out such that the coating amount of silver in the image-forming layer is 1.8 g/m² and the dry thickness of the surface protective layer is 3.4 μm. The dual knife coater comprised an array of two knife coating blades. The support was cut into a length corresponding to the volumes of the used liquids, and a knife having a hinge was raised and disposed on the coater bed. Then, the knife was lowered and fixed at a predetermined position. The position of the knife was adjusted in accordance with the wedge measured by an ammeter, which was controlled by a screw knob. The knife #1 was raised to a gap corresponding to the sum of the thickness of the support and the desired wet thickness of the image-forming layer (the layer #1). The knife #2 was raised to the position corresponding to the sum of the thickness of the support, the wet thickness of the image-forming layer (the layer #1), the desired thickness of the surface protective layer (the layer #2). Then, the applied coating liquids were dried at 75° C. by air flow with a dew point of 10° C. over 15 minute.

The chemical structures of the compounds used in Example 1 are illustrated below.

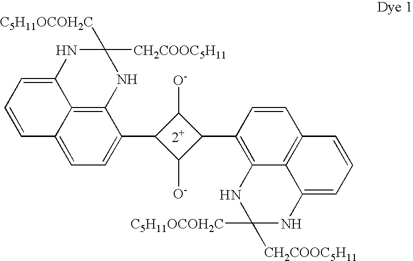

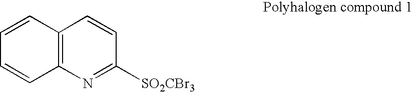

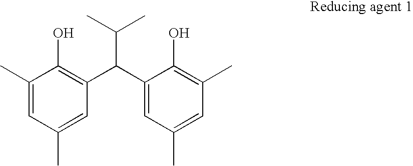

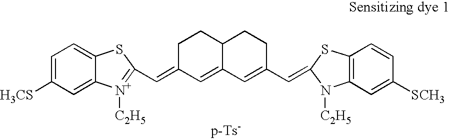

4. Evaluation of Photographic Properties

(Preparation)

The obtained samples were cut into a half size (43 cm in length×35 cm in width), enclosed in the following packaging material under conditions of 25° C. and 50% RH, and stored at ordinary temperature for 2 weeks.

(Packaging Material)

Structure: PET 10 μm/PE 12 μm/aluminum foil 9 μm/Ny 15 μm/polyethylene containing 3% by mass of carbon 50 μm.

Oxygen transmittance: 0.02 ml/atm·m²·25° C.·day.

Water transmittance: 0.10 g/atm·m²·25° C.·day.

The above photothermographic materials were evaluated as follows.

(Exposure and Development of Photothermographic Material)

An exposing apparatus, which used a semiconductor laser converted into vertical multimode with a wavelength of 800 to 820 nm by high frequency superposition as an exposure light source, was experimentally manufactured. Each sample of the photothermographic materials 1 to 14 was exposed by the exposing apparatus such that the image-forming layer side thereof was laser-scanned. The incidence angle of the scanned laser light to the exposure face of the photothermographic material was 75 degree. Then, each sample was heat-developed at 124° C. for 13 seconds by an automatic developing apparatus comprising a heat drum such that the protective layer on the image-forming layer side came into contact with the heat drum. Thus-obtained images were evaluated by using a densitometer.

4-1. Evaluation of Photographic Properties

Each photothermographic material, which was enclosed in the packaging material and stored for 2 weeks, was taken from the packaging material. The photothermographic material was exposed and heat-developed as above immediately after opening the packaging material, and the obtained image was evaluated by a Macbeth TD904 densitometer (visible density). The maximum density (Dmax), the density of the unexposed portion (Dmin), and the sensitivity corresponding to the density of 1.2 (the logarithm of the reciprocal of the laser energy) were obtained. Dmax and Dmin were shown in Table 1 as values relative to those of the sample of the photothermographic material 1, and the sensitivity was shown in Table 1 as difference from the sensitivity of the photothermographic material 1 (ΔS1.2).

4-2. Evaluation of Color Tone Change

Each photothermographic material, which was enclosed in the packaging material and stored for 2 weeks, was exposed and heat-developed immediately after opening the packaging material in the above manner, and the color tone of the portion with the density of 1.0 was measured by a colorimeter SPECTROLINO available from Gretag-Macbeth AG using a fluorescent lamp F6 as a light source, to obtain chromaticity A (L*_{A}, a*_{A}, b*_{A}) in the CIELAB color space. On the other hand, another sample of each photothermographic material was left under conditions of 28° C. and 70% RH for 3 days after it was taken from the packaging material, and then exposed and heat-developed in the above manner. The color tone of the portion exposed equally to the above portion showing the chromaticity A was measured to obtain chromaticity B (L*_{B}, a*_{B}, b*_{B}). ΔE was obtained from the colorimetric values L*a*b* of the chromaticities A and B, whereby the color tone change of the photothermographic material was evaluated. ΔE was calculated using the following equation:

ΔE={(ΔL*)²+(Δa*)²+(Δb*)²}^{1/2},

in which ΔL*=L*_{A}−L*_{B}, Δa*=a*_{A}−a*_{B}, and Δb*=b*_{A}−b*_{B}.

4-3. Evaluation of Image Storability

Each of the photothermographic materials 1 to 14 was heat-developed, and the obtained image was put in a light-shielding bag and stored for 7 days under conditions of 60° C. and 40% RH. Then, the optical density of the unexposed portion was measured. Thus-obtained optical density was expressed as Dmin2, and the difference (ΔDmin) between Dmin and Dmin2 was calculated using the following equation: ΔDmin=Dmin2−Dmin. ΔDmin was shown in Table 1 as values relative to that of the sample of the photothermographic material 1.

TABLE 1

| | | | | | | Color | | |
|---|---|---|---|---|---|---|---|---|
| | Binder | | | | | Tone | Image | |
| Sample | | Tg | Reducing | | Sensitivity | Change | Storability | |
| No. | Kind | (° C.) | Agent | Dmax | ΔS1.2 | ΔE | ΔDmin | Note |
| 1 | Comparative | 65 | Reducing | 100 | 0.0 | 4.8 | 100 | Comparative |
| | Polymer 1 | | agent 1 | | | | | |
| 2 | Comparative | 131 | Reducing | 69 | −0.53 | 0.6 | 62 | Comparative |
| | Polymer 2 | | agent 1 | | | | | |
| 3 | Comparative | 65 | I-5 | 110 | 0.12 | 5.5 | 189 | Comparative |
| | Polymer 1 | | | | | | | |
| 4 | Comparative | 131 | I-5 | 85 | −0.35 | 0.5 | 75 | Comparative |
| | Polymer 2 | | | | | | | |
| 5 | P-2 | 75 | Reducing | 91 | −0.21 | 0.7 | 93 | Comparative |
| | | | agent 1 | | | | | |
| 6 | P-2 | 75 | I-5 | 105 | 0.14 | 0.3 | 60 | The present |
| | | | | | | | | invention |
| 7 | P-5 | 88 | I-5 | 107 | 0.13 | 0.2 | 62 | The present |
| | | | | | | | | invention |
| 8 | P-6 | 104 | I-5 | 106 | 0.13 | 0.2 | 61 | The present |
| | | | | | | | | invention |
| 9 | P-3 | 110 | I-5 | 103 | 0.10 | 0.3 | 59 | The present |
| | | | | | | | | invention |
| 10 | P-5 | 88 | I-4 | 108 | 0.13 | 0.3 | 62 | The present |
| | | | | | | | | invention |
| 11 | P-5 | 88 | I-6 | 106 | 0.13 | 0.2 | 55 | The present |
| | | | | | | | | invention |
| 12 | P-6 | 104 | I-9 | 107 | 0.14 | 0.3 | 62 | The present |
| | | | | | | | | invention |
| 13 | P-6 | 104 | I-10 | 107 | 0.13 | 0.1 | 60 | The present |
| | | | | | | | | invention |
| 14 | P-6 | 104 | I-13 | 105 | 0.12 | 0.2 | 57 | The present |
| | | | | | | | | invention |

As shown in Table 1, the photothermographic materials, which used the binder having a glass-transition temperature of 70 to 110° C. and the reducing agent represented by general formula (R), showed excellent printout properties and high sensitivity with little fogging.

### Example 2

Coating liquids 201 to 214 for image-forming layer were prepared in the same manner as Coating liquid 1 to 14 of Example 1 except for using Sensitizing dye 2 instead of Sensitizing dye 1, respectively. Further, photothermographic materials 201 to 214 were produced using Coating liquids 201 to 214 in the same manner as Example 1, respectively.

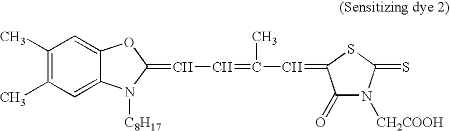

(Exposure and Development of Photosensitive Material)

The photothermographic material 201 to 214 were exposed by Fuji Medical Dry Laser Imager FM-DP L having the 660 nm semiconductor laser with the maximum output of 60 mW (IIIB), and heat-developed by 4 panel heaters at 112° C., 119° C., 121° C., and 121° C., for 24 seconds, respectively.

(Evaluation of Photographic Properties)

The photographic properties of the photothermographic material 201 to 214 were evaluated in the same manner as Example 1. The results are shown in Table 2.

TABLE 2

| | | | | | | Color | | |
|---|---|---|---|---|---|---|---|---|
| | Binder | | | | | Tone | Image | |
| Sample | | Tg | Reducing | | Sensitivity | Change | Storability | |
| No. | Kind | (° C.) | Agent | Dmax | ΔS1.2 | ΔE | ΔDmin | Note |
| 201 | Comparative | 65 | Reducing | 100 | 0.0 | 5.2 | 100 | Comparative |
| | Polymer 1 | | agent 1 | | | | | |
| 202 | Comparative | 131 | Reducing | 72 | −0.35 | 0.5 | 51 | Comparative |
| | Polymer 2 | | agent 1 | | | | | |
| 203 | Comparative | 65 | I-5 | 107 | 0.08 | 6.0 | 210 | Comparative |
| | Polymer 1 | | | | | | | |
| 204 | Comparative | 131 | I-5 | 86 | −0.22 | 0.6 | 66 | Comparative |
| | Polymer 2 | | | | | | | |
| 205 | P-2 | 75 | Reducing | 92 | −0.12 | 0.5 | 86 | Comparative |
| | | | agent 1 | | | | | |
| 206 | P-2 | 75 | I-5 | 103 | 0.07 | 0.3 | 55 | The present |
| | | | | | | | | invention |
| 207 | P-5 | 88 | I-5 | 102 | 0.08 | 0.3 | 53 | The present |
| | | | | | | | | invention |
| 208 | P-6 | 104 | I-5 | 105 | 0.07 | 0.2 | 51 | The present |
| | | | | | | | | invention |
| 209 | P-3 | 110 | I-5 | 101 | 0.03 | 0.1 | 52 | The present |
| | | | | | | | | invention |
| 210 | P-5 | 88 | I-4 | 105 | 0.08 | 0.2 | 53 | The present |
| | | | | | | | | invention |
| 211 | P-5 | 88 | I-6 | 104 | 0.08 | 0.3 | 54 | The present |
| | | | | | | | | invention |
| 212 | P-6 | 104 | I-9 | 105 | 0.07 | 0.1 | 53 | The present |
| | | | | | | | | invention |
| 213 | P-6 | 104 | I-10 | 103 | 0.08 | 0.3 | 53 | The present |
| | | | | | | | | invention |
| 214 | P-6 | 104 | I-13 | 104 | 0.07 | 0.2 | 52 | The present |
| | | | | | | | | invention |

Dmax and image storability of each sample were shown as values relative to those of the sample 201, and sensitivity was shown as the difference from the sensitivity of the sample 201.

As shown in Table 2, also in the case where Sensitizing dye 2 for a red laser was used and the photothermographic material was exposed by the red laser, the photothermographic materials, which used the binder having a glass-transition temperature of 70 to 110° C. and the reducing agent represented by general formula (R), were excellent in the results of evaluation of Dmax, the sensitivity, and the image storability.

### Example 3

1) Composition Change of Organic Silver Salt and Redispersion of Organic Silver Salt in Organic Solvent

An organic silver salt dispersion was prepared in the same manner as Example 1 except that the composition comprising 55% by mole of behenic acid, 28% by mole of arachidic acid, and 17% by mole of stearic acid was changed as shown in Table 3, and the slurry was not two-pass-dispersed by a pressure homogenizer GM-2 available from S. M. T. Co. but dispersed under conditions of the peripheral speed of 13 m and the residence time in the mill of 0.5 minutes by a media-dispersing apparatus filled in 80 vol % with 1 mm Zr beads available from Toray Industries, Inc.

TABLE 3

| | Behenic | Arachidic | Stearic |
|---|---|---|---|
| | Acid | Acid | Acid |
| Organic Silver Salt 1 | 55% by | 28% by | 17% by |
| | mole | mole | mole |
| Organic Silver Salt 2 | 42% by | 34% by | 24% by |
| | mole | mole | mole |
| Organic Silver Salt 3 | 70% by | 20% by | 10% by |
| | mole | mole | mole |

2) Preparation of Coating Liquid 301 to 313 for Image-Forming Layer

To 50 g of each organic silver salt dispersion shown in Table 4 was added 15.1 g of MEK while stirring the dispersion under nitrogen flow, and kept at 24° C., in the same manner as Example 1. 2.5 ml of a 10% by mass methanol solution of following Antifoggant 1 was added to the resultant mixture and stirred for 15 minutes. 2.5 g of a 0.24% by mass MEK solution of Sensitizing dye 3, and 1.8 ml of a solution containing 20% by mass of Dye adsorption aid and potassium acetate (Dye adsorption aid/potassium acetate=1/5 by mass) were added thereto and stirred for 15 minutes. Then, 7 ml of a methanol solution containing 4-chloro-2-benzoylbenzoic acid and a super-sensitizer of 5-methyl-2-mercaptobenzimidazole (mass ratio=25:2, total amount: 3.0% by mass of the methanol solution), 3.5×10⁻³ mol of polyhalogen compound 1, and a comparative reducing agent 1 and a reducing agent of the present invention shown in table 4 were added thereto and stirred for 1 hour. The resulting mixture was cooled to 13° C. and further stirred for 30 minutes. 48 g of a binder shown in Table 4 was added to and sufficiently dissolved in the mixture at 13° C., and then the following additives were added. These procedures were carried out under nitrogen flow. The amount of the reducing agent was described in the same manner as Example 1.

| | |
|---|---|
| Phthalazine | 1.5 g |
| Tetrachlorophthalic acid | 0.5 g |
| 4-Methylphthalic acid | 0.5 g |
| Hydrogen bonding compound 1 | 0.67 g |
| Development accelerator 1 | 0.046 g |
| Development accelerator 2 | 0.039 g |
| Dye 2 | 2.0 g |
| Aliphatic isocyanate DESMODUR N3300 | 1.10 g |
| available from Movey Co. | |

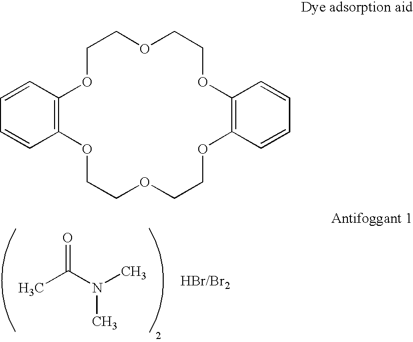

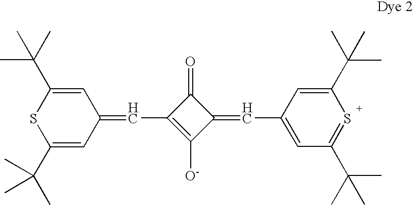

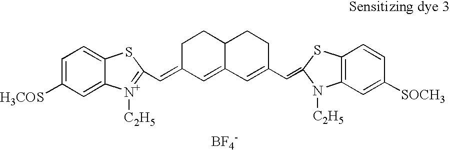

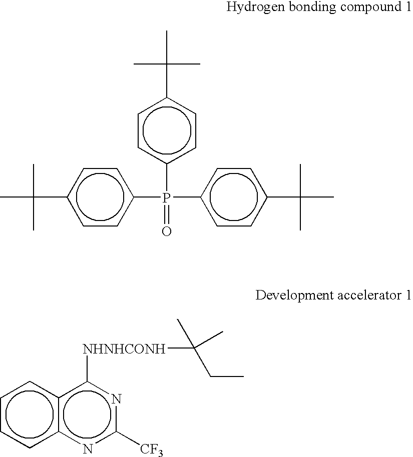

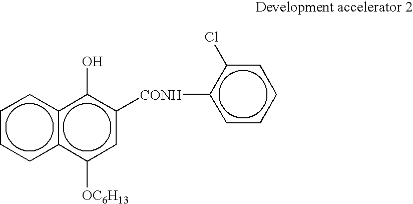

3) Coating

Image-forming layer: Each Coating liquid was applied onto the opposite side of the back layer side of the support used in Example 1, such that the coating amount of silver was 1.65 g/m² and the amount of polyvinyl butyral of the binder was 7.8 g/m².

Surface protective layer: The coating liquid having the following composition was applied such that the wet thickness was 100 μm.

| | |
|---|---|
| Acetone | 175 ml |
| 2-Propanol | 40 ml |
| Methanol | 15 ml |
| Cellulose acetate | 8 g |
| Phthalazine | 1.5 g |
| 4-Methyl phthalazine | 0.72 g |
| Tetrachlorophthalic acid | 0.22 g |
| Tetrachlorophthalic anhydride | 0.5 g |
| Monodispersed silica having average | 1% by mass of binder |
| particle size of 4 μm and variation | |
| coefficient of 20% | |
| Fluorine-containing active agent | 0.5 g |
| (SURFLON KH40 available from | |
| Asahi Glass Co. Ltd.) | |

4) Exposure and Heat Development

Each photothermographic material was exposed and heat-developed in the same manner as Example 1. The obtained image was evaluated in the same manner as Example 1. The results were shown in Table 4.

TABLE 4

| | | | | | | | | Color | | |
|---|---|---|---|---|---|---|---|---|---|---|
| | | Organic | | | | | | Tone | Image | |
| Sample | | silver | Reducing | Development | | | Sensitivity | Change | storability | |
| No. | Binder | salt | agent | accelerator | Dmax | Dmin | ΔS1.2 | ΔE | ΔDmin | Note |
| 301 | Comparative | 1 | I-1 | 1, 2 | 100 | 100 | 0.0 | 4.9 | 100 | Comparative |
| | Polymer 1 | | | | | | | | | |
| 302 | P-5 | 1 | I-1 | 1, 2 | 102 | 60 | 0.02 | 0.3 | 43 | The present |
| | | | | | | | | | | invention |
| 303 | P-5 | 1 | I-2 | 1, 2 | 101 | 62 | 0.01 | 0.4 | 42 | The present |
| | | | | | | | | | | invention |
| 304 | P-5 | 1 | I-3 | 1, 2 | 100 | 62 | 0.01 | 0.2 | 45 | The present |
| | | | | | | | | | | invention |
| 305 | P-5 | 1 | I-5 | 1, 2 | 106 | 65 | 0.07 | 0.3 | 48 | The present |
| | | | | | | | | | | invention |
| 306 | P-5 | 2 | I-1 | 1, 2 | 104 | 85 | 0.02 | 0.6 | 62 | The present |
| | | | | | | | | | | invention |
| 307 | P-5 | 2 | I-2 | 1, 2 | 103 | 88 | 0.01 | 0.7 | 63 | The present |
| | | | | | | | | | | invention |
| 308 | P-5 | 2 | I-3 | 1, 2 | 102 | 88 | 0.02 | 0.8 | 62 | The present |
| | | | | | | | | | | invention |
| 309 | P-5 | 2 | I-5 | 1, 2 | 108 | 92 | 0.08 | 0.8 | 67 | The present |
| | | | | | | | | | | invention |
| 310 | P-5 | 3 | I-1 | 1, 2 | 101 | 60 | 0.01 | 0.3 | 46 | The present |
| | | | | | | | | | | invention |
| 311 | P-5 | 3 | I-2 | 1, 2 | 101 | 62 | 0.01 | 0.2 | 47 | The present |
| | | | | | | | | | | invention |
| 312 | P-5 | 3 | I-3 | 1, 2 | 102 | 62 | 0.0 | 0.1 | 45 | The present |
| | | | | | | | | | | invention |
| 313 | P-5 | 3 | I-5 | 1, 2 | 104 | 63 | 0.01 | 0.2 | 49 | The present |
| | | | | | | | | | | invention |

Dmax, Dmin and image storability of each sample were shown as values relative to those of the sample 301, and sensitivity was shown as the difference from the sensitivity of the sample 301.

As shown in Table 4, the photothermographic materials, which used the binder having a glass-transition temperature of 70 to 110C. and the reducing agent represented by general formula (R), were excellent in the results of evaluation of Dmax, the sensitivity, and the image storability, as Example 1. Further, it was clear that the fogging properties and the image storability were improved with the other advantages when the organic silver salt contains 50% by mole or more of silver behenate.

### Example 4

Coating liquids for image-forming layer were prepared in the same manner as Coating liquid 5 of Example 1 except for using a development accelerator shown in Table 5, respectively, the mole ratio of the development accelerator to the reducing agent being 5% by mole. Then, photothermographic materials 31 to 33 were produced using the coating liquids in the same manner as Example 1 respectively.

TABLE 5

| | | | | | | | Color | | |
|---|---|---|---|---|---|---|---|---|---|
| | Binder | | | | | | Tone | Image | |
| Sample | | Tg | Reducing | Development | | Sensitivity | Change | Storability | |
| No. | Kind | (° C.) | Agent | Accelerator | Dmax | ΔS1.2 | ΔE | ΔDmin | Note |
| 5 | P-2 | 75 | I-5 | — | 105 | 0.14 | 0.3 | 60 | The present |
| | | | | | | | | | invention |
| 31 | P-2 | 75 | I-5 | A-1 | 110 | 0.25 | 0.2 | 61 | The present |
| | | | | | | | | | invention |
| 32 | P-2 | 75 | I-5 | A-7 | 112 | 0.25 | 0.1 | 62 | The present |
| | | | | | | | | | invention |
| 33 | P-2 | 75 | I-5 | A-12 | 109 | 0.20 | 0.2 | 60 | The present |
| | | | | | | | | | invention |

Dmax and image storability of each sample were shown as values relative to those of the sample 1, and sensitivity was shown as the difference from the sensitivity of the sample 1.

As shown in Table 5, the development activity and the apparent sensitivity were increased by adding the development accelerators. The photothermographic materials using the development accelerators showed excellent Dmax, the sensitivity, the color tone change, and the image storability, without deterioration of the color tone change and the image storability.

### Example 5

10,000 samples of each of the photothermographic materials 1 and 5 produced as Example 1 were continuously developed by the apparatus used in Example 1, to examine the conveyability. Probability of defective feeding was obtained for each photothermographic material. The results were shown in Table 6.

TABLE 6

| | Probability of | |
|---|---|---|
| Sample | Defective Feeding | Note |
| 1 | 0.12% | Comparative |
| 5 | 0.02% | The present invention |

The photothermographic materials of the present invention are excellent in the film storability, the image storability, the development activity, and the conveyability.

What is claimed is:

1. A photothermographic material comprising:
an image-forming layer comprising a photosensitive silver halide, a reducing agent, a binder, and a non-photosensitive organic silver salt, wherein said binder has a glass-transition temperature of 70° C. to 110° C., and said reducing agent is a compound represented by the following general formula (R): 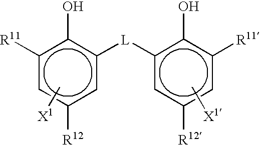
wherein R¹¹ and R^{11′} each independently represents a secondary or tertiary alkyl group having a carbon number of 3 to 15, R¹² and R^{12′} each independently represents a hydrogen atom or a substituent which is capable of substituting on a benzene ring, L represents a —S— group or a —CHR¹³— group, R¹³ represents a hydrogen atom or an alkyl group having a carbon number of 1 to 20, and X¹ and X^{1′} each independently represents a hydrogen atom or a substituent which is capable of substituting on a benzene ring.

2. A photothermographic material comprising:
an image-forming layer comprising a photosensitive silver halide, a reducing agent, a binder, and a non-photosensitive organic silver salt, wherein said binder has a glass-transition temperature of 70° C. to 110° C., and said photothermographic material comprises a development accelerator.

3. The photothermographic material according to claim 1, further comprising a development accelerator.

4. A photothermographic material comprising:
an image-forming layer comprising a photosensitive silver halide, a reducing agent, a binder, and a non-photosensitive organic silver salt, wherein said binder has a glass-transition temperature of 70° C. to 110° C., and said non-photosensitive organic silver salt comprises silver behenate in an amount of 50% by mole or more.

5. The photothermographic material according to claim 1, wherein said non-photosensitive organic silver salt comprises silver behenate in an amount of 50% by mole or more.

6. The photothermographic material according to claim 2, wherein said non-photosensitive organic silver salt comprises silver behenate in an amount of 50% by mole or more.

7. The photothermographic material according to claim 3, wherein said non-photosensitive organic silver salt comprises silver behenate in an amount of 50% by mole or more.

8. The photothermographic material according to claim 1, wherein a coating liquid for forming said photothermographic material comprises an organic solvent.

9. The photothermographic material according to claim 8, wherein said binder comprises a polyvinyl acetal.

10. The photothermographic material according to claim 1, wherein a coating amount of silver is 1 g/m² to 1.9 g/m².

11. The photothermographic material according to claim 2, wherein a coating liquid for forming said photothermographic material comprises an organic solvent.

12. The photothermographic material according to claim 11, wherein said binder comprises a polyvinyl acetal.

13. The photothermographic material according to claim 2, wherein a coating amount of silver is 1 g/m² to 1.9 g/m².

14. The photothermographic material according to claim 4, wherein a coating liquid for forming said photothermographic material comprises an organic solvent.

15. The photothermographic material according to claim 14, wherein said binder comprises a polyvinyl acetal.

16. The photothermographic material according to claim 4, wherein a coating amount of silver is 1 g/m² to 1.9 g/m².

17. A method for forming an image comprising: exposing the photothermographic material according to claim 1 to a radiation source; and developing the photothermographic material;
wherein the maximum density of said photothermographic material is 3.3 or more.

18. A method for forming an image comprising: exposing the photothermographic material according to claim 2 to a radiation source; and developing the photothermographic material;
wherein the maximum density of the photothermographic material is 3.3 or more.

19. A method for forming an image comprising: exposing the photothermographic material according to claim 4 to a radiation source; and developing the photothermographic material;
wherein the maximum density of the photothermographic material is 3.3 or more.

20. A method for forming an image comprising: exposing the photothermographic material according to claim 2 to a radiation source;and developing the photothermographic material;
wherein the photothermographic material is developed by heating for 3 to 13 seconds.
